(19) United States
(12) Patent Application Publication
(10) Pub. No.: US 2014/0075201 A1
(43) Pub. Date: Mar. 13, 2014

(54) INFORMATION PROCESSING DEVICE, INFORMATION PROCESSING METHOD, AND PROGRAM

(71) Applicant: SONY CORPORATION, Minato-ku (JP)

(72) Inventors: Harunaga HIWATARI, Kanagawa (JP); Masanobu Katagi, Kanagawa (JP); Kazuya Kamio, Tokyo (JP)

(73) Assignee: SONY CORPORATION, Minato-ku (JP)

(21) Appl. No.: 14/018,896

(22) Filed: Sep. 5, 2013

(30) Foreign Application Priority Data
Sep. 11, 2012 (JP) 2012-199410

(51) Int. Cl. H04L 9/32

(52) U.S. Cl. CPC H04L 9/3247
USPC 713/176

(57) ABSTRACT

There is provided an information processing device including a distribution control unit configured to cause one or two external devices to distributively perform a repetitive process in a process for signature or authentication in which the repetitive process is included, and a processing unit configured to perform the process for signature or authentication using a processing result of each of the external devices.

### BACKGROUND

The present technology relates to an information processing device, an information processing method, and a program.

A signature scheme and an authentication scheme have been used in various circumstances.

In addition, signature schemes and authentication schemes in which various algorithms are used have been developed. As a technology relating to an MQ (Multivariate Quadratic) signature scheme and an MQ authentication scheme (a scheme based on MQ problems), for example, the technology disclosed in “Public-Key Identification Schemes Based on Multivariate Quadratic Polynomials” presented by Koichi Sakumoto, Taizo Shirai, and Harunaga Hiwatari in CRYPTO 2011 is exemplified, and as a technology relating to an MC (Multivariate Cubic) signature scheme and an MC authentication scheme (a scheme based on MC problems), for example, the technology disclosed in “Public-Key Identification Schemes Based on Multivariate Cubic Polynomials” presented by Koichi Sakumoto in PKC 2012 is exemplified. In addition, as a technology relating to an SD (Syndrome Decoding) signature scheme and an SD authentication scheme (a scheme based on SD problems), for example, the technology disclosed in “A New Identification Scheme Based on Syndrome Decoding” presented by Jacques Stern in CRYPTO 1993 is exemplified, and as a technology relating to a CLE (Constrained Linear Equations) signature scheme and a CLE authentication scheme (a scheme based on CLE problems), for example, the technology disclosed in “Designing Identification Schemes with Keys of Short Size” presented by Jacques Stern in CRYPTO 1994 is exemplified. In addition, as a technology relating to a PP (Permuted Perceptrons) signature scheme and a PP authentication scheme, for example, the technology disclosed in “A New NP-Complete Problem and Public-Key Identification” written by David Pointcheval and Guillaume Poupard in Designs, Codes and Cryptography 2003 is exemplified.

### SUMMARY

For signature schemes and authentication schemes in use, for example, the signature schemes and authentication schemes using the technologies disclosed in “Public-Key Identification Schemes Based on Multivariate Quadratic Polynomials,” “Public-Key Identification Schemes Based on Multivariate Cubic Polynomials,” “A New Identification Scheme Based on Syndrome Decoding,” “Designing Identification Schemes with Keys of Short Size,” and “A New NP-Complete Problem and Public-Key Identification,” a large amount of computation is necessary in a process for signature or authentication (authentication process) in order to reinforce security.

Meanwhile, the signature schemes and the authentication schemes have been used in various circumstances, and are desired to be executed at a high speed even in, for example, devices with little computing resources such as sensor nodes on a sensor network.

It is desirable to provide a novel and improved information processing device, information processing method, and program which can speed up a process for signature or authentication.

According to an embodiment of the present disclosure, there is provided an information processing device including a distribution control unit configured to cause one or two external devices to distributively perform a repetitive process in a process for signature or authentication in which the repetitive process is included, and a processing unit configured to perform the process for signature or authentication using a processing result of each of the external devices.

Further, according to an embodiment of the present disclosure, there is provided an information processing device including a distribution control unit configured to divide signature data or certification data to be verified in a process for verification in which a repetitive process is included, and cause one or two external devices to distributively perform the repetitive process in the process for verification with regard to the divided signature data or certification data, and a processing unit configured to verify the signature data or the certification data using a processing result of each of the external devices.

Further, according to an embodiment of the present disclosure, there is provided an information processing device including a distribution control unit configured to divide a process in a repetitive process in the process for verification in which the repetitive process for verifying signature data or certification data is included, and cause one or two external devices to distributively perform the divided process, and a processing unit configured to verify the signature data or the certification data using a processing result of each of the external devices.

According to an embodiment of the present disclosure, there is provided an information processing method including causing one or two external devices to distributively perform a repetitive process in the process for signature or authentication in which the repetitive process is included, and performing the process for signature or authentication using a processing result of each of the external devices.

Further, according to an embodiment of the present disclosure, there is provided an information processing method including dividing signature data or certification data to be verified in a process for verification in which a repetitive process is included, and causing one or two external devices to distributively perform the repetitive process in the process for verification with regard to the divided signature data or certification data, and verifying the signature data or the certification data using a processing result of each of the external devices.

Further, according to an embodiment of the present disclosure, there is provided a program for causing a computer to execute causing one or two external devices to distributively perform a repetitive process in a process for signature or authentication in which the repetitive process is included, and performing the process for signature or authentication using a processing result of each of the external devices.

Further, according to an embodiment of the present disclosure, there is provided a program for causing a computer to execute dividing signature data or certification data to be verified in a process for verification in which a repetitive process is included, and causing one or two external devices to distributively perform the repetitive process in the process for verification with regard to the divided signature data or certification data, and verifying the signature data or the certification data using a processing result of each of the external devices.

According to the embodiments of the present technology described above, a process for signature or authentication can be sped up.

### BRIEF DESCRIPTION OF THE DRAWINGS

FIG. 1 is a descriptive diagram for describing an overview of an information processing method according to an embodiment of the present technology;

FIG. 2 is a descriptive diagram for describing the overview of the information processing method according to the embodiment;

FIG. 3 is a descriptive diagram for describing the overview of the information processing method according to the embodiment;

FIG. 4 is a descriptive diagram for describing another overview of the information processing method according to the embodiment;

FIG. 5 is a descriptive diagram for describing still another overview of the information processing method according to the embodiment;

FIG. 6 is a descriptive diagram illustrating a first example of a distribution control process of a first information processing device according to the embodiment;

FIG. 7 is a sequence diagram illustrating an example of a process of the information processing method according to the embodiment relating to a process for signature or authentication;

FIG. 8 is a descriptive diagram illustrating another example of the first example of the distribution control process in the first information processing device according to the embodiment;

FIG. 9 is a descriptive diagram illustrating still another example of the first example of the distribution control process in the first information processing device according to the embodiment;

FIG. 10 is a descriptive diagram illustrating a second example of the distribution control process in the first information processing device according to the embodiment;

FIG. 11 is a descriptive diagram illustrating another example of the second example of the distribution control process in the first information processing device according to the embodiment;

FIG. 12 is a descriptive diagram for describing a third example of the distribution control process in the first information processing device according to the embodiment;

FIG. 13 is a sequence diagram illustrating the third example of the distribution control process in the first information processing device according to the embodiment;

FIG. 14 is a sequence diagram illustrating an example of a process of the information processing method according to the embodiment relating to a process for verification;

FIG. 15 is a descriptive diagram for describing a third example of the distribution control process in a second information processing device according to the embodiment;

FIG. 16 is a sequence diagram illustrating another example of the process of the information processing method according to the embodiment relating to the process for verification;

FIG. 17 is a block diagram illustrating a configuration example of the first information processing device according to the embodiment;

FIG. 18 is an illustrative diagram showing an example of a hardware configuration of the first information processing device according to the embodiment; and

FIG. 19 is a block diagram illustrating a configuration example of the second information processing device according to the embodiment.

### DETAILED DESCRIPTION OF THE EMBODIMENT(S)

Hereinafter, a preferred embodiment of the present technology will be described in detail with reference to the appended drawings. Note that, in this specification and the appended drawings, structural elements that have substantially the same function and structure are denoted with the same reference numerals, and repeated explanation of these structural elements is omitted.

In addition, hereinafter, description will be provided in the following order.

1. Information processing method according to an embodiment

2. Information processing device according to the embodiment

3. Program according to the embodiment

### (Information Processing Method According to an Embodiment)

Prior to describing a configuration of an information processing device according to an embodiment, an information processing method according to an embodiment will first be described. Hereinafter, the information processing method according to the embodiment will be described exemplifying a case in which the information processing device according to the embodiment performs a process relating to the information processing method according to the embodiment.

### [1] Overview of the Information Processing Method According to the Embodiment

As described above, in the signature schemes and authentication schemes in use, a large amount of computation is necessary in the process for signature or authentication (authentication process) in order to reinforce security. In addition, in the process for verification to verify signature data in the signature schemes and certification data in the authentication schemes as described above (authentication verification process), a large amount of computation is likewise necessary. Prior to describing an overview of the information processing method according to the embodiment, first, the reason for the necessity of a large amount of computation in the process for signature or authentication and the process for verification will be described.

### [1-1] The Reason for the Necessity of a Large Amount of Computation in the Process for Signature or Authentication and the Process for Verification

### [i] The Reason for the Necessity of a Large Amount of Computation in the Process for Signature and the Process for Verification

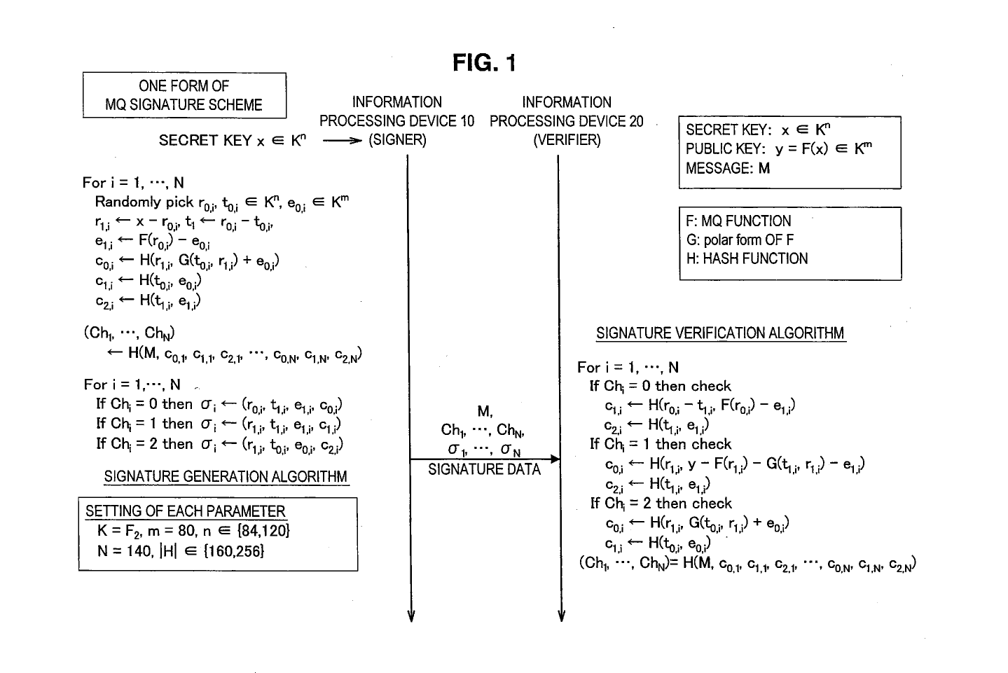

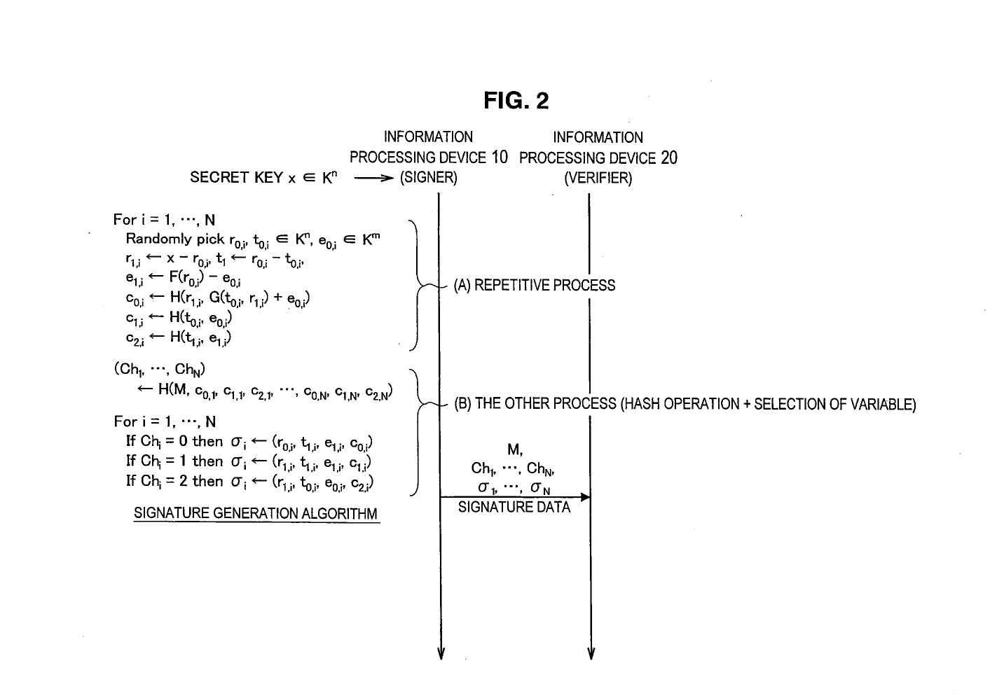

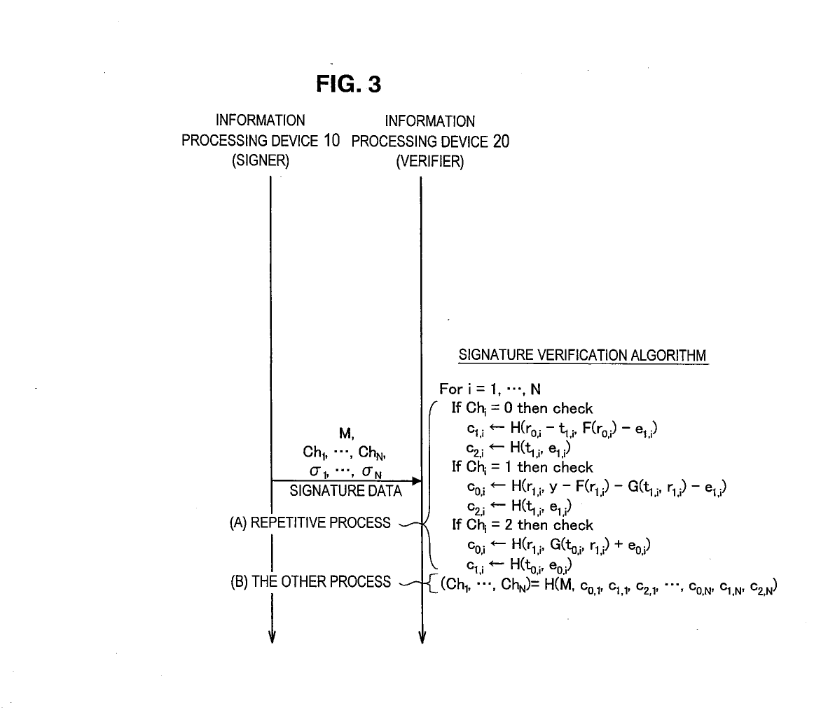

FIGS. 1 to 3 are descriptive diagrams for describing an overview of the information processing method according to the present embodiment. Here, FIG. 1 illustrates an example of a signature generation algorithm and an example of a signature verification algorithm as an example of a process according to the MQ signature scheme disclosed in, for example, “Public-Key Identification Schemes Based on Multivariate Quadratic Polynomials.” In addition, FIG. 2 illustrates the example of the signature generation algorithm illustrated in FIG. 1, and FIG. 3 illustrates the example of the signature verification algorithm illustrated in FIG. 1.

As illustrated in FIG. 1, in the MQ signature scheme, for example, one information processing device 10 performs a process for signature (for example, a process of the signature generation algorithm illustrated in FIG. 1).

Here, as illustrated in FIG. 2, the process for signature in the MQ signature scheme is classified into a repetitive process ((A) illustrated in FIG. 2) in which an independent process is repeated and the other process ((B) illustrated in FIG. 2). The information processing device 10 repeats the independent process N times (where N is a positive integer) in the repetitive process, performs a process of performing a hash operation and a process of selecting variables one time each as the process (B), and thereby generates signature data. Here, in order to reinforce security, it is necessary to increase the number of times the independent process is performed in the repetitive process, and thus the amount of computation in the process for signature according to the present embodiment increases.

In addition, as illustrated in FIG. 1, for example, the other information processing device 20 performs a process for verification (for example, a process of the signature verification algorithm illustrated in FIG. 1) using the signature data (data on the result of the process for signature) transmitted from the information processing device 10 in the MQ signature scheme.

Here, as illustrated in FIG. 3, the process for verification in the MQ signature scheme is classified into a repetitive process in which an independent process is repeated ((A) illustrated in FIG. 3) and the other process ((B) illustrated in FIG. 3) in the same manner as the process for signature in the MQ signature scheme illustrated in FIG. 2. The information processing device 20 repeats the independent process N times in the repetitive process, and verifies the signature data by performing a process of performing a hash operation one time as the process (B). Here, in order to reinforce security, it is necessary to increase the number of times the independent process is performed in the repetitive process, and thus the amount of computation in the process for verification according to the present embodiment increases.

As illustrated in FIGS. 1 and 2, the process for signature in the MQ signature scheme necessitates a large amount of computation in order to reinforce security. In addition, as shown with reference to FIGS. 1 and 3, the process for verification in the MQ signature scheme necessitates a large amount of computation in order to reinforce security.

[ii] First Example with Regard to the Reason for the Necessity of a Large Amount of Computation in the Process for Authentication and a Process for Verification

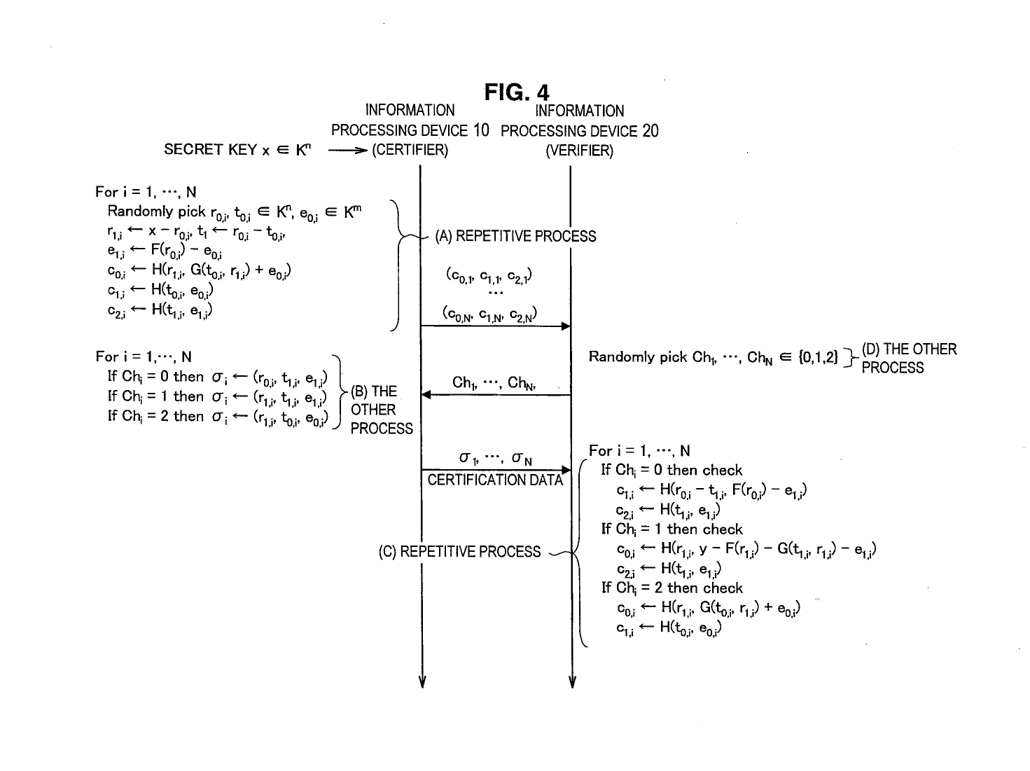

FIG. 4 is a descriptive diagram for describing another overview of the information processing method according to the present embodiment. Here, FIG. 4 illustrates an example of an authentication algorithm and an example of an authentication verification algorithm as an example of a process according to the MQ authentication scheme disclosed in, for example, “Public-Key Identification Schemes Based on Multivariate Quadratic Polynomials.”

As illustrated in FIG. 4, for example, in the MQ authentication scheme, one information processing device 10 performs a process for authentication. Here, as illustrated in FIG. 4, the process for authentication in the MQ authentication scheme is classified into a repetitive process ((A) illustrated in FIG. 4) in which an independent process is repeated and the other process ((B) illustrated in FIG. 4). The information processing device 10 repeats the independent process N times in the repetitive process, performs a process of selecting variables as the process (B), and thereby generates certification data. Here, in order to reinforce security, it is necessary to increase the number of times the independent process is performed in the repetitive process, and thus the amount of computation in the process for authentication according to the present embodiment increases.

In addition, as illustrated in FIG. 4, for example, the other information processing device 20 performs a process for verification using the certification data transmitted from the information processing device 10 in the MQ authentication scheme. Here, as illustrated in FIG. 4, the process for verification in the MQ authentication scheme is classified into a repetitive process in which an independent process is repeated ((C) illustrated in FIG. 4) and the other process ((D) illustrated in FIG. 4). The information processing device 20 performs a process of randomly selecting one value from 0, 1, and 2 one time as the process (D), repeats the independent process N times in the repetitive process, and thereby verifies the certification data. Here, in order to reinforce security, it is necessary to increase the number of times the independent process is performed in the repetitive process, and thus the amount of computation in the process for verification according to the present embodiment increases.

As shown with reference to FIG. 4, in order to reinforce security, the process for authentication in the MQ authentication scheme necessitates a large amount of computation. In addition, as shown with reference to FIG. 4, in order to reinforce security, the process for verification in the MQ authentication scheme necessitates a large amount of computation.

[iii] Second Example with Regard to the Reason for the Necessity of a Large Amount of Computation in the Process for Authentication and the Process for Verification.

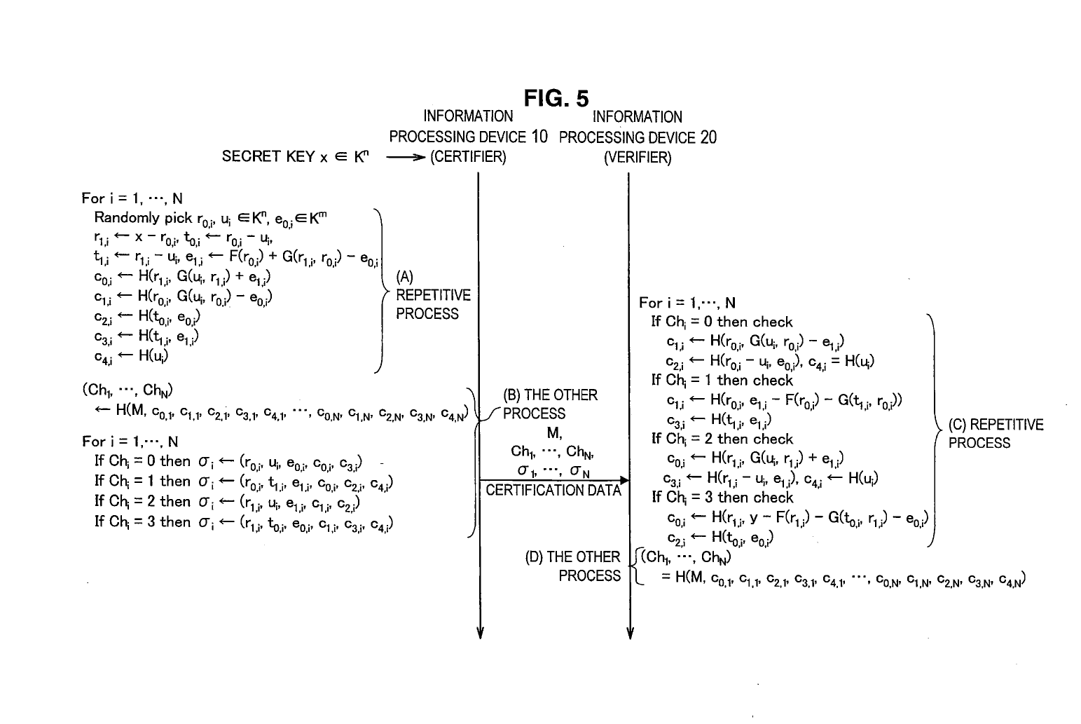

FIG. 5 is a descriptive diagram for describing still another overview of the information processing method according to the present embodiment. Here, FIG. 5 illustrates an example of an authentication algorithm and an example of an authentication verification algorithm as an example of a process according to the MC authentication scheme disclosed in, for example, “Public-Key Identification Schemes Based on Multivariate Cubic Polynomials.”

As illustrated in FIG. 5, for example, in the MC authentication scheme, one information processing device 10 performs a process for authentication. Here, as illustrated in FIG. 5, the process for authentication in the MC authentication scheme is classified into a repetitive process in which an independent process is repeated ((A) illustrated in FIG. 5) and the other process ((B) illustrated in FIG. 5). The information processing device 10 repeats the independent process N times in the repetitive process, performs a process of performing a hash operation and a process of selecting variables as the process (B), and thereby generates certification data. Here, in order to reinforce security, it is necessary to increase the number of times the independent process is performed in the repetitive process, and thus the amount of computation in the process for authentication according to the present embodiment increases.

In addition, as illustrated in FIG. 5, for example, the other information processing device 20 performs the process for verification using the certification data transmitted from the information processing device 10 in the MC authentication scheme. Here, as illustrated in FIG. 5, the process for verification in the MC authentication scheme is classified into a repetitive process in which an independent process is repeated ((C) illustrated in FIG. 5) and the other process ((D) illustrated in FIG. 5). The information processing device 20 repeats the independent process N times in the repetitive process, performs the process of performing a hash operation one time as the process (D), and thereby verifies the certification data. Here, in order to reinforce security, it is necessary to increase the number of times the independent process is performed in the repetitive process, and thus the amount of computation in the process for verification according to the present embodiment increases.

As shown with reference to FIG. 5, in order to reinforce security, the process for authentication in the MC authentication scheme necessitates a large amount of computation. In addition, as shown with reference to FIG. 5, in order to reinforce security, the process for verification in the MC authentication scheme necessitates a large amount of computation.

As shown in [i] to [iii] described above, for example, the process for signature or authentication and the process for verification necessitate a large amount of computation.

It should be noted that such a repetitive process in which an independent process is repeated is also included in a process for signature in a signature scheme and a process for verification in the signature scheme using the technologies disclosed in, for example, “Public-Key Identification Schemes Based on Multivariate Cubic Polynomials,” “A New Identification Scheme Based on Syndrome Decoding,” “Designing Identification Schemes with Keys of Short Size,” and “A New NP-Complete Problem and Public-Key Identification.” Thus, a large amount of computation is also necessitated in the process for signature in the signature scheme and the process for verification in the signature scheme using the technologies disclosed in the above documents, in the same manner as in the process for signature in the MQ signature scheme and the process for verification in the MQ signature scheme using the technology disclosed in “Public-Key Identification Schemes Based on Multivariate Quadratic Polynomials” described above.

In addition, such a repetitive process in which an independent process is repeated is also included in a process for authentication in an authentication scheme and a process for verification in the authentication scheme using the technologies disclosed in, for example, “A New Identification Scheme Based on Syndrome Decoding,” “Designing Identification Schemes with Keys of Short Size,” and “A New NP-Complete Problem and Public-Key Identification.” Thus, a large amount of computation is also necessitated in the process for authentication in an authentication scheme and the process for verification in the authentication scheme using the technologies disclosed in the above documents, in the same manner as in the process for authentication in the authentication scheme and the process for verification in the authentication scheme using the technologies disclosed in “Public-Key Identification Schemes Based on Multivariate Quadratic Polynomials,” and “Public-Key Identification Schemes Based on Multivariate Cubic Polynomials” described above.

### [1-2] Information Processing Method According to the Present Embodiment Relating to a Process for Signature or Authentication

As described above, when a repetitive process in which an independent process is repeated is included in a process for signature or authentication, a large amount of computation is necessitated in the process for signature or authentication. In addition, the other process according to the present embodiment in the process for signature or authentication can be said to be a process having a smaller processing amount than the repetitive process according to the present embodiment in the process for signature or authentication.

Thus, an information processing device performing the process for signature or authentication (an information processing device serving as a signer or certifier, and hereinbelow referred to as a “first information processing device”) according to the present embodiment causes a repetitive process performed in the process for signature or authentication that includes the repetitive process in which an independent process is repeated to be performed in one or two or more external devices in a distributed manner (distribution control process). In addition, the first information processing device according to the present embodiment performs the process for signature or authentication using processing results from the external devices (execution process).

Here, since the repetitive process in the process for signature or authentication according to the present embodiment is a process in which an independent process is repeated, for example, an i^{th} (where i is a positive integer) process in the repetitive process according to the present embodiment does not affect an i+1^{th} process in the repetitive process according to the present embodiment. In other words, even if the processes in the repetitive process according to the present embodiment are respectively distributively performed in one or two or more external devices, they do not affect a result of the process for signature or authentication (for example, generated signature data or certification data) according to the present embodiment.

In addition, by causing the respective processes in the repetitive process according to the present embodiment to be distributively performed in one or two or more external devices, the processing amount (the amount of computation) of the process for signature or authentication according to the present embodiment performed in the first information processing device according to the present embodiment decreases.

Therefore, by performing (1) the distribution control process and (2) the execution process as a process of the information processing method according to the present embodiment, the first information processing device according to the present embodiment can speed up the process for signature or authentication.

In addition, since the processing amount of the process for signature or authentication according to the present embodiment performed in the first information processing device according to the present embodiment decreases due to the process of the information processing method according to the present embodiment, a load imposed on the process performed by the first information processing device according to the present embodiment is also reduced. Thus, by using the information processing method according to the present embodiment, the first information processing device according to the present embodiment can execute the process for signature or authentication according to the present embodiment at a high speed even if the first information processing device according to the present embodiment is a device with little computing resources such as a sensor node on a sensor network.

### [1-3] Information Processing Method According to the Present Embodiment Relating to a Process for Verification

As described above, when the repetitive process in which an independent process is repeated is included in a process for verification, a large amount of computation is necessitated in the process for verification. In addition, the other process according to the present embodiment in the process for verification can be said to be a process having a smaller processing amount than the repetitive process according to the present embodiment in the process for verification.

Thus, an information processing device performing the process for verification according to the present embodiment (information processing device serving as a verifier, and hereinafter referred to as a “second information processing device”) divides signature data or certification data verified in the process for verification in which the repetitive process is included, and causes the repetitive process performed in the process for verification with regard to the divided signature data or certification data to be distributively performed in one or two external devices (distribution control process). In addition, the second information processing device according to the present embodiment verifies the signature data or certification data (verification process) using processing results from the external devices.

Here, since the repetitive process in the process for verification according to the present embodiment is a process in which an independent process is repeated, for example, a process on one divided piece of the signature data or certification data in the repetitive process according to the present embodiment does not affect another process on another divided piece of the signature data or certification data in the repetitive process according to the present embodiment. In other words, even if the second information processing device according to the present embodiment causes the process on the divided signature data or certification data in the repetitive process to be distributively performed in one or two or more external devices, they do not affect a result of the process for verification according to the present embodiment.

In addition, by causing the repetitive process in the process for verification on the divided signature data or certification data to be distributively performed in one or two or more external devices, the processing amount (the amount of computation) of the process for verification according to the present embodiment performed in the second information processing device according to the present embodiment decreases.

Therefore, by performing (I) the distribution control process and (II) the verification process as a process of the information processing method according to the present embodiment, the second information processing device according to the present embodiment can speed up the process for verification.

In addition, since the processing amount (the amount of computation) of the process for verification according to the present embodiment in the second information processing device according to the present embodiment decreases due to the process of the information processing method according to the present embodiment, a load imposed on the process performed by the second information processing device according to the present embodiment is also reduced. Thus, by using the information processing method according to the present embodiment, the second information processing device according to the present embodiment can execute the process for verification according to the present embodiment at a high speed even if the second information processing device according to the present embodiment is a device with little computing resources.

### [2] Process of the Information Processing Method According to the Present Embodiment

Next, the process of the information processing method according to the present embodiment will be described in more detail.

Hereinafter, the process of the information processing method according to the present embodiment relating to the process for signature or authentication will be described mainly exemplifying a case in which the first information processing device according to the present embodiment performs a process for signature, in other words, in which the first information processing device according to the present embodiment is a device serving as a signer.

In addition, hereinbelow, the process of the information processing method according to the present embodiment relating to the process for signature or authentication will be described mainly exemplifying a case in which the first information processing device according to the present embodiment performs the process for signature in the MQ signature scheme. It should be noted that the process of the information processing method according to the present embodiment relating to the process for signature or authentication is not limited to being applied to the MQ signature scheme relating to the technology disclosed in, for example, “Public-Key Identification Schemes Based on Multivariate Quadratic Polynomials.” The process of the information processing method according to the present embodiment relating to the process for signature or authentication can be applied to, for example, a signature scheme in which the repetitive process is included, such as the signature scheme relating to the technologies disclosed in “Public-Key Identification Schemes Based on Multivariate Cubic Polynomials,” “A New Identification Scheme Based on Syndrome Decoding,” “Designing Identification Schemes with Keys of Short Size,” and “A New NP-Complete Problem and Public-Key Identification.” In addition, the process of the information processing method according to the present embodiment relating to the process for signature or authentication can also be applied to an authentication scheme in which the repetitive process is included, such as the authentication scheme relating to the technologies disclosed in, for example, “Public-Key Identification Schemes Based on Multivariate Quadratic Polynomials,” “Public-Key Identification Schemes Based on Multivariate Cubic Polynomials,” “A New Identification Scheme Based on Syndrome Decoding,” “Designing Identification Schemes with Keys of Short Size,” and “A New NP-Complete Problem and Public-Key Identification.”

In addition, hereinbelow, the process of the second information processing method according to the present embodiment relating to the process for verification will be described mainly exemplifying a case in which the second information processing device according to the present embodiment performs the process for verification in a signature scheme, in other words, in which the second information processing device according to the present embodiment is a device serving as a verifier in the signature scheme.

In addition, hereinbelow, the process of the information processing method according to the present embodiment relating to the process for verification will be described mainly exemplifying a case in which the second information processing device according to the present embodiment performs the process for verification in the MQ signature scheme. It should be noted that the process of the information processing method according to the present embodiment relating to the process for verification is not limited to being applied to the MQ signature scheme relating to the technology disclosed in, for example, “Public-Key Identification Schemes Based on Multivariate Quadratic Polynomials.” The process of the information processing method according to the present embodiment relating to the process for verification can be applied to, for example, a signature scheme in which the repetitive process is included, such as the signature scheme relating to the technologies disclosed in “Public-Key Identification Schemes Based on Multivariate Cubic Polynomials,” “A New Identification Scheme Based on Syndrome Decoding,” “Designing Identification Schemes with Keys of Short Size,” and “A New NP-Complete Problem and Public-Key Identification.” In addition, the process of the information processing method according to the present embodiment relating to the process for verification can also be applied to an authentication scheme in which the repetitive process is included, such as the authentication scheme relating to the technologies disclosed in, for example, “Public-Key Identification Schemes Based on Multivariate Quadratic Polynomials,” “Public-Key Identification Schemes Based on Multivariate Cubic Polynomials,” “A New Identification Scheme Based on Syndrome Decoding,” “Designing Identification Schemes with Keys of Short Size,” and “A New NP-Complete Problem and Public-Key Identification.”

In addition, hereinbelow, the process of the information processing method according to the present embodiment will be described mainly exemplifying a case in which an external device to which the first information processing device according to the present embodiment and the second information processing device according to the present embodiment distribute processes is a server. Note that it is needless to say that the external device according to the present embodiment is not limited to a server.

### [2-1] Process of the Information Processing Method According to the Present Embodiment Relating to the Process for Signature or Authentication

First, the process of the information processing method according to the present embodiment relating to the process for signature or authentication will be described. Hereinbelow, description will be provided exemplifying the case in which the first information processing device according to the present embodiment performs the process of the information processing method according to the present embodiment.

### (1) Distribution Control Process

The first information processing device according to the present embodiment distributes a repetitive process in the process for signature or authentication in which the repetitive process is included to one or two external devices to be performed therein.

### (1-1) First Example of the Distribution Control Process

The first information processing device according to the present embodiment distributes the repetitive process in the process for signature or authentication to, for example, a plurality of external devices to be performed therein.

To be more specific, the first information processing device according to the present embodiment equally divides the repetitive process in the process for signature or authentication into the number of external devices. Then, the first information processing device according to the present embodiment causes the plurality of external devices to perform all of the divided repetitive processes.

It should be noted that, when the number of repetitions of the repetitive process in the process for signature or authentication is equally divided into the number of external devices, for example, there may be a case in which the result obtained by dividing the number of repetitions of the repetitive process according to the present embodiment by the number of external devices is not an integer. When the result obtained by dividing the number of repetitions of the repetitive process according to the present embodiment by the number of external devices is not an integer as described above, the first information processing device according to the present embodiment adjusts the number of processes in the repetitive process according to the present embodiment to be allocated to each of the external devices so that, for example, the number of processes in the repetitive process according to the present embodiment distributively performed in the external devices becomes an integer.

In other words, “equally dividing the repetitive process in the process for signature or authentication into the number of external devices” in the present embodiment includes adjusting the number of processes in the repetitive process according to the present embodiment to be allocated to each of the external devices so that, for example, the number of processes in the repetitive process according to the present embodiment distributively performed in the external devices becomes an integer.

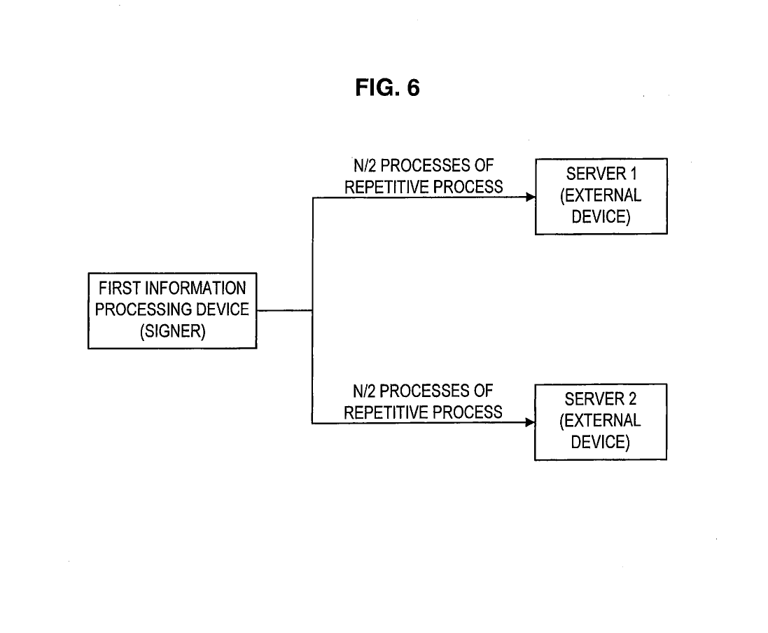

FIG. 6 is a descriptive diagram illustrating a first example of the distribution control process of the first information processing device according to the embodiment. Here, FIG. 6 illustrates the example in which the first information processing device according to the embodiment distributes the repetitive process in the process for signature to two external devices of a server 1 and a server 2 to be performed therein. In addition, the server 1 and the server 2 illustrated in FIG. 6 each have a secret key corresponding to the process for signature. The secret key corresponding to the process for signature is given to each of the server 1 and the server 2 through, for example, a user operation performed by the user of the first information processing device according to the embodiment.

When there are two external devices as illustrated in FIG. 6, for example, the first information processing device according to the embodiment equally divides the repetitive process in which a process is repeated N times in the process for signature into the number of external devices “2.” Then, the first information processing device according to the embodiment causes the divided repetitive process, i.e., N/2 processes of the repetitive process, to be performed in each of the server 1 and the server 2 as illustrated in, for example, FIG. 6. It should be noted that, when N/2 is not a positive integer, the first information processing device according to the embodiment adjusts the number of processing times so that the number of processes in the repetitive process performed in the server 1 and the server 2 becomes a positive integer as described above.

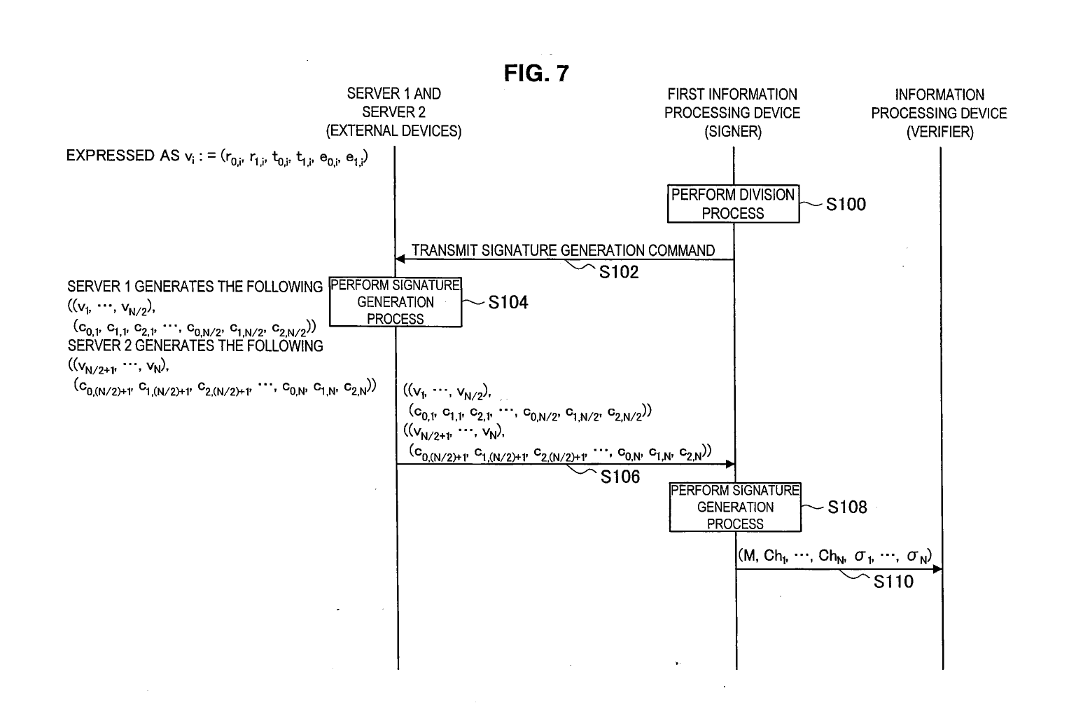

FIG. 7 is a sequence diagram illustrating an example of the process of the information processing method according to the present embodiment relating to the process for signature or authentication. Here, FIG. 7 illustrates the example of the process when the first information processing device according to the embodiment causes N/2 processes of the repetitive process in the process for signature or authentication to be performed in each of the server 1 and the server 2, as illustrated in FIG. 6. In addition, in FIG. 7, the processes of Steps S100 and S102 correspond to the process of (1) (distribution control process), and the processes of Steps S108 and S110 correspond to the process of (2) (execution process) to be described later.

The first information processing device according to the embodiment equally divides the repetitive process in the process for signature into, for example, the number of servers (an example of an external device) “2” (division process of S100).

After the process of Step S100 is performed, the first information processing device according to the embodiment transmits a signature generation command according to the result of the process of Step S100 to the server 1 and the server 2 (S102). The first information processing device according to the embodiment transmits the signature generation command by conducting communication with the server 1 and the server 2 via, for example, a communication unit (to be described later) provided in the device itself (the first information processing device according to the embodiment) or an external communication device.

Here, the signature generation command according to the present embodiment is data serving as a trigger that causes the repetitive process in the process for signature or authentication to be performed in the external devices. The signature generation command according to the present embodiment includes, for example, information (data) indicating which processing part of the repetitive process in the process for signature or authentication should be performed.

To be more specific, in Step S102, the first information processing device according to the embodiment transmits, for example, the signature generation command for causing first to N/2^{th} processes of the repetitive process to be performed to the server 1, and transmits the signature generation command for causing (N/2+1)^{th} to N^{th} processes of the repetitive process to be performed to the server 2.

Each of the server 1 and the server 2 that have received the signature generation command transmitted from the first information processing device according to the embodiment in Step S102 performs N/2 processes of the repetitive process in the process for signature based on the received signature generation command (signature generation process of S104). To be more specific, the server 1 performs the processes of i=1 to i=N/2 of the repetitive process, for example, indicated by (A) of FIG. 2, and the server 2 performs the processes of i=(N/2+1) to i=N of the repetitive process, for example, indicated by (A) of FIG. 2.

When the process of Step S104 is completed, each of the server 1 and the server 2 transmits the result of the repetitive process in the process for signature to the first information processing device according to the present embodiment (S106). Here, each of the server 1 and the server 2 also transmits, for example, variables used in the repetitive process in the process for signature together with the result of the repetitive process in the process for signature.

The first information processing device according to the present embodiment that receives the result of the repetitive process in the process for signature transmitted from each of the server 1 and the server 2 in Step S106 generates signature data using the received result of the repetitive process in the process for signature (signature generation process of Step S108). The first information processing device according to the present embodiment generates the signature data by performing, for example, the other process indicated by (B) of FIG. 2.

When the process of Step S108 is completed, the first information processing device according to the present embodiment transmits the generated signature data to the information processing device serving as a verifier that performs the process of the signature verification algorithm illustrated in, for example, FIG. 1 (process for verification) (S110). The first information processing device according to the present embodiment transmits the signature data by communicating with the information processing device serving as a verifier via, for example, the communication unit (to be described later) provided in the device itself (the first information processing device according to the present embodiment) or an external communication device.

When the first information processing device according to the present embodiment causes each of the server 1 and the server 2 to equally perform the processes of the repetitive process in the process (1) (distribution control process) as illustrated in, for example, FIG. 6, the process illustrated in, for example, FIG. 7 is performed as the process of the information processing method according to the present embodiment relating to the process for signature or authentication.

Here, as described above, since the repetitive process in the process for signature according to the present embodiment is a process in which an independent process is repeated, the processes in the repetitive process according to the present embodiment do not affect the generated signature data even when each of the processes is distributively performed in the server 1 and the server 2. In addition, by causing each of the processes in the repetitive process according to the present embodiment to be distributively performed in the server 1 and the server 2, the processing amount (amount of computation) of the process for signature according to the present embodiment in the first information processing device according to the present embodiment decreases.

Thus, as illustrated in FIG. 7, for example, when the first information processing device according to the present embodiment causes each of the server 1 and the server 2 to equally perform the processes in the repetitive process according to the present embodiment in the process (1) (distribution control process) and thereby performs the process (2) (execution process) to be described later, the first information processing device according to the present embodiment can speed up the process for signature.

It should be noted that the first example of the distribution control process performed in the first information processing device according to the present embodiment is not limited to the example illustrated in FIG. 6.

When there are two or more external devices that can execute the repetitive process in the process for signature or authentication, for example, the first information processing device according to the present embodiment may cause the repetitive process in the process for signature or authentication to be distributively performed in each of the two or more external devices.

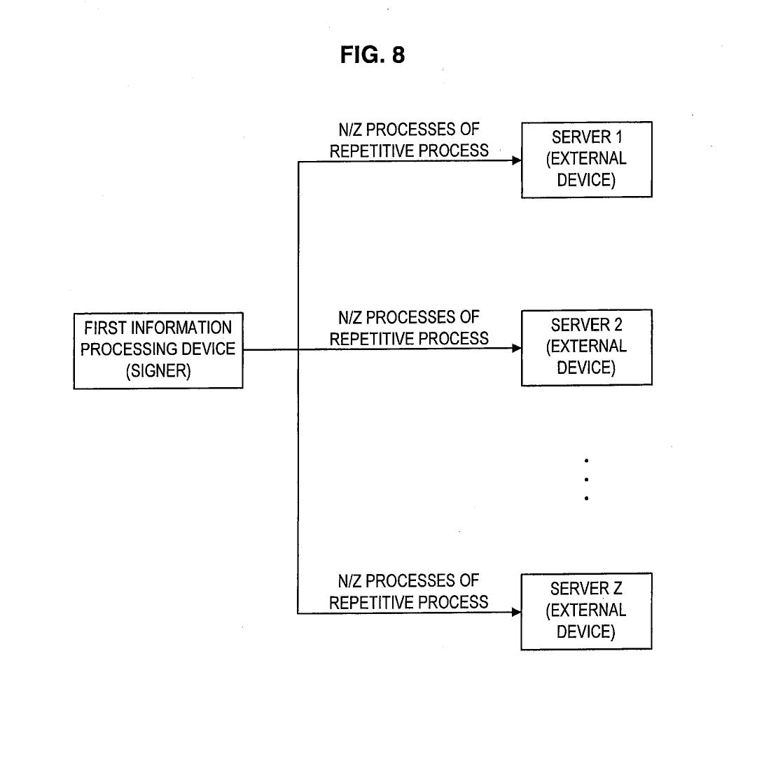

FIG. 8 is a descriptive diagram illustrating another example of the first example of the distribution control process in the first information processing device according to the present embodiment. Herein, FIG. 8 illustrates the example in which the first information processing device according to the present embodiment causes the repetitive process in the process for signature to be distributively performed in Z external devices (Z is an integer equal to or greater than 2) which are the server 1 to a server Z. In addition, each server (an example of an external device) shown in FIG. 8 has a secret key corresponding to each process for signature. The secret key corresponding to the process for signature is given to each of the servers (an example of an external device) through, for example, a user operation by the user of the first information processing device according to the present embodiment.

As illustrated in FIG. 8, when there are Z servers (an example of an external device) that can execute the repetitive process in the process for signature, for example, the first information processing device according to the present embodiment equally divides the repetitive process in which an independent process is repeated N times in the process for signature into the number of external devices “Z.” Then, the first information processing device according to the present embodiment causes the divided repetitive process, i.e., N/Z processes of the repetitive process, to be performed in each of the server 1 to the server Z as illustrated in, for example, FIG. 8. It should be noted that, when N/Z is not a positive integer, the first information processing device according to the present embodiment adjusts the number of processes so that the number of processes in the repetitive process performed in each of the server 1 to the server Z becomes a positive integer as described above.

As described above, since the repetitive process in the process for signature according to the present embodiment is a process in which an independent process is repeated, the processes in the repetitive process according to the present embodiment do not affect the generated signature data even when each is made to be distributively performed in the server 1 to the server Z. In addition, by causing each of the processes in the repetitive process according to the present embodiment to be distributively performed in the server 1 to the server Z, the processing amount (amount of computation) of the process for signature according to the present embodiment performed in the first information processing device according to the present embodiment decreases.

Thus, as illustrated in FIG. 8, for example, when the first information processing device according to the present embodiment causes each of the server 1 and the server 2 to equally perform the processes in the repetitive process according to the present embodiment in the process (1) (distribution control process) and thereby performs the process (2) (execution process) to be described later, the first information processing device according to the present embodiment can speed up the process for signature.

In addition, in the above description, the example in which the first information processing device according to the present embodiment equally divides the repetitive process in the process for signature or authentication into the number of external devices is shown, but the first example of the distribution control process performed in the first information processing device according to the present embodiment is not limited to the above example.

For example, the first information processing device according to the present embodiment may unequally divide the repetitive process in the process for signature or authentication into the number of external devices. When the process is unequally divided, the first information processing device according to the present embodiment causes the plurality of external devices to perform all processes of the divided repetitive process.

Here, for example, computing resources of the plurality of external devices that can execute the repetitive process in the process for signature or authentication are not limited to being the same, and computing resources of a certain external device may be more than computing resources of another external device.

Thus, the first information processing device according to the present embodiment unequally divides the repetitive process according to the present embodiment based on, for example, the scale of the computing resources of each of external devices so that a larger number of processes in the repetitive process according to the present embodiment are performed by an external device having more computing resources than another.

To be more specific, the first information processing device according to the present embodiment acquires, for example, data indicating information expressing computation capability (for example, FLOPS (Floating-point Operations Per Second)), or information relating to computing resources such as information expressing a load state (for example, data indicating a load rate) from each of the external devices. Then, the first information processing device according to the present embodiment determines the scale of the computing resources of the external devices from, for example, such acquired information relating to the computing resources, and unequally divides the repetitive process according to the present embodiment so that a larger number of processes in the repetitive process according to the present embodiment are performed by an external device having more computing resources than another.

In addition, the first information processing device according to the present embodiment causes, for example, the unequally divided repetitive process to be distributively performed so that a larger number of processes in the repetitive process according to the present embodiment are performed by an external device having more computing resources than another.

As described above, for example, by unequally dividing the repetitive process according to the present embodiment based on the scale of the computing resources of the external devices and by causing an external device having more computing resources than another to perform a larger number of processes in the repetitive process according to the present embodiment, a processing time of the repetitive process according to the present embodiment in the external device can be shortened.

Note that it is needless to say that the first information processing device according to the present embodiment can unequally divide the repetitive process in the process for signature or authentication based on the number of external devices rather than the computing resources of the external devices.

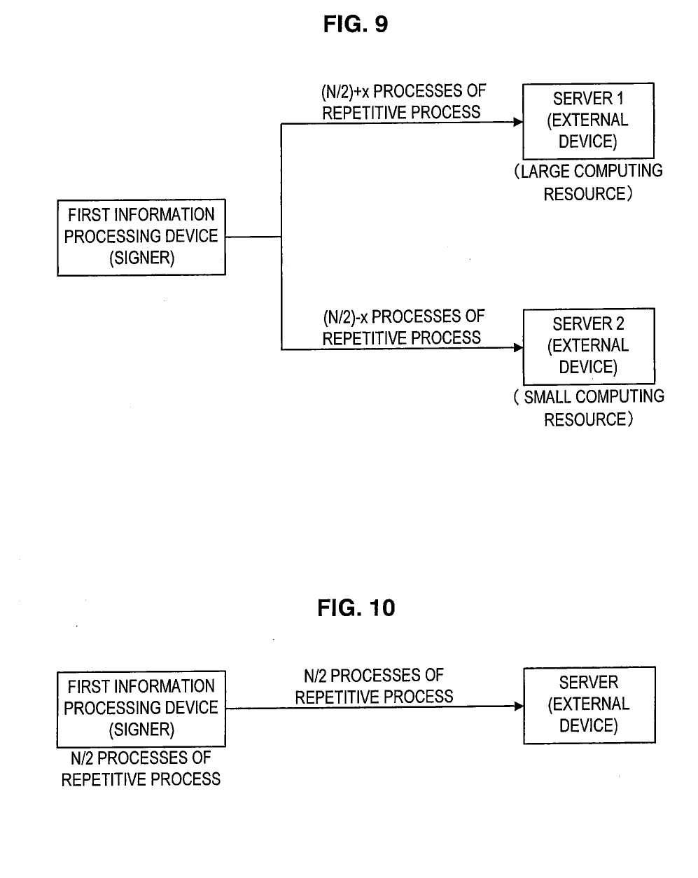

FIG. 9 is a descriptive diagram illustrating still another example of the first example of the distribution control process in the first information processing device according to the present embodiment. Herein, FIG. 9 illustrates the example in which the first information processing device according to the present embodiment causes the repetitive process in the process for signature to be distributively performed in two external devices which are the server 1 and the server 2 in the same manner as in the example illustrated in FIG. 6. In addition, each of the server 1 and the server 2 shown in FIG. 9 has a secret key corresponding to the process for signature. The secret key corresponding to the process for signature is given to each of the server 1 and the server 2 through, for example, a user operation by the user of the first information processing device according to the present embodiment.

As illustrated in FIG. 9, for example, computing resources of the server 1 and the server 2 are not limited to being the same, and the computing resources of one server may be more than the computing resources of the other server. Thus, the first information processing device according to the present embodiment unequally divides the repetitive process in which the process is repeated N times in the process for signature into “2” that is the number of external devices.

For example, the first information processing device according to the present embodiment causes the server 1 having more computing resources to perform (N/2+x) processes (x is an integer smaller than N/2) out of N processes in the repetitive process. In addition, the first information processing device according to the present embodiment causes the server 2 having less computing resources to perform (N/2−x) processes out of N processes in the repetitive process.

As described above, since the repetitive process in the process for signature according to the present embodiment is a process in which an independent process is repeated, the processes in the repetitive process according to the present embodiment do not affect the generated signature data even when they are unequally distributively performed in the server 1 and the server 2. In addition, by causing each of the processes in the repetitive process according to the present embodiment to be distributively performed in the server 1 and the server 2, the processing amount (amount of computation) of the process for signature according to the present embodiment performed in the first information processing device according to the present embodiment decreases.

Thus, as illustrated in FIG. 9, for example, when the first information processing device according to the present embodiment causes each of the server 1 and the server 2 to unequally perform the processes in the repetitive process according to the present embodiment in the process (1) (distribution control process) and thereby performs the process (2) (execution process) to be described later, the first information processing device according to the present embodiment can speed up the process for signature.

It should be noted that FIG. 9 illustrates the example in which the number of servers (an example of an external device) is 2 as in the example illustrated in FIG. 6, but the first information processing device according to the present embodiment may cause two or more servers (an example of an external device) to perform the repetitive process in the process for signature as in the example illustrated in FIG. 8. Even when the repetitive process in the process for signature is unequally performed in the two or more servers (an example of an external device) as in the example illustrated in FIG. 8, the first information processing device according to the present embodiment can speed up the process for signature as in the example illustrated in FIG. 8.

### (1-2) Second Example of Distribution Control Process

The first example of the distribution control process shows that the first information processing device according to the present embodiment causes all processes of the repetitive process in the process for signature or authentication to be distributively performed in a plurality of external devices. However, the process of the information processing method according to the present embodiment relating to the process for signature or authentication is not limited to causing all processes of the repetitive process according to the present embodiment to be distributively performed in the plurality of external devices.

For example, the first information processing device according to the present embodiment may cause the repetitive process in the process for signature or authentication to be distributively performed in one or two or more external devices and the device itself (the first information processing device according to the present embodiment, to be specific, for example, a processing unit to be described later, and the same applies hereinbelow).

To be more specific, the first information processing device according to the present embodiment equally divides the repetitive process in the process for signature or authentication into, for example, the total number of external devices and the device itself. Then, the first information processing device according to the present embodiment causes the external devices and the device itself to perform the divided repetitive process.

It should be noted that, when the number of repetitions of the repetitive process in the process for signature or authentication is equally divided into the total number of external devices and the device itself, for example, there is a case in which the result obtained by dividing the number of repetitions of the repetitive process by the total number is not an integer. When the result obtained by dividing the number of repetitions of the repetitive process according to the present embodiment by the total number of external devices and the device itself is not an integer, the first information processing device according to the present embodiment, for example, adjusts the number of processes in the repetitive process according to the present embodiment to be allocated to each of the external devices and the device itself so that the number of processes in the repetitive process according to the present embodiment to be distributively performed in each of the external devices and the device itself becomes an integer as described above.

In other words, “equally dividing the repetitive process in the process for signature or authentication into the total number of external devices and the device itself” according to the present embodiment also includes, for example, adjusting the number of processes in the repetitive process according to the present embodiment to be allocated to the external devices and the device itself so that the number of processes in the repetitive process according to the present embodiment to be distributively performed in each of the external devices and the device itself described above becomes an integer.

FIG. 10 is a descriptive diagram illustrating a second example of the distribution control process in the first information processing device according to the present embodiment. Herein, FIG. 10 illustrates the example in which the first information processing device according to the present embodiment causes the repetitive process in the process for signature to be distributively performed in one external device which is the server 1 and the device itself. In addition, the server 1 and the first information processing device shown in FIG. 10 each have a secret key corresponding to the process for signature. The secret key corresponding to the process for signature is given to the server 1 through, for example, a user operation by the user of the first information processing device according to the present embodiment.

When there is one external device as shown in FIG. 10, for example, the first information processing device according to the present embodiment equally divides the repetitive process in which a process is repeated N times in the process for signature into the total number “2” of the number of external devices “1” and the device itself. Then, the first information processing device according to the present embodiment causes the divided repetitive process, i.e., N/2 processes in the repetitive process, to be performed in each of the server 1 and the device itself as illustrated in, for example, FIG. 10. It should be noted that, when N/2 is not a positive integer, the first information processing device according to the present embodiment adjusts the number of processing times so that the number of processes in the repetitive process performed in the server 1 and the device itself becomes a positive integer as described above.

Here, since the repetitive process in the process for signature according to the present embodiment is a process in which an independent process is repeated as described above, the processes in the repetitive process according to the present embodiment do not affect the generated signature data even when each is distributively performed in the server 1 and the device itself. In addition, by causing some of the processes in the repetitive process according to the present embodiment to be distributively performed in the server 1, the processing amount (amount of computation) of the process for signature according to the present embodiment performed in the first information processing device according to the present embodiment decreases.

Thus, as illustrated in FIG. 10, for example, when the first information processing device according to the present embodiment causes each of the server 1 and the device itself to equally perform the processes in the repetitive process according to the present embodiment in the process (1) (distribution control process) and thereby performs the process (2) (execution process) to be described later, the first information processing device according to the present embodiment can speed up of the process for signature.

It should be noted that the second example of the distribution control process performed by the first information processing device according to the present embodiment is not limited to the example illustrated in FIG. 10.

When there are two or more external devices that can execute the repetitive process in the process for signature or authentication, for example, the first information processing device according to the present embodiment may cause the repetitive process in the process for signature or authentication to be distributively performed in each of the two or more external devices and the device itself.

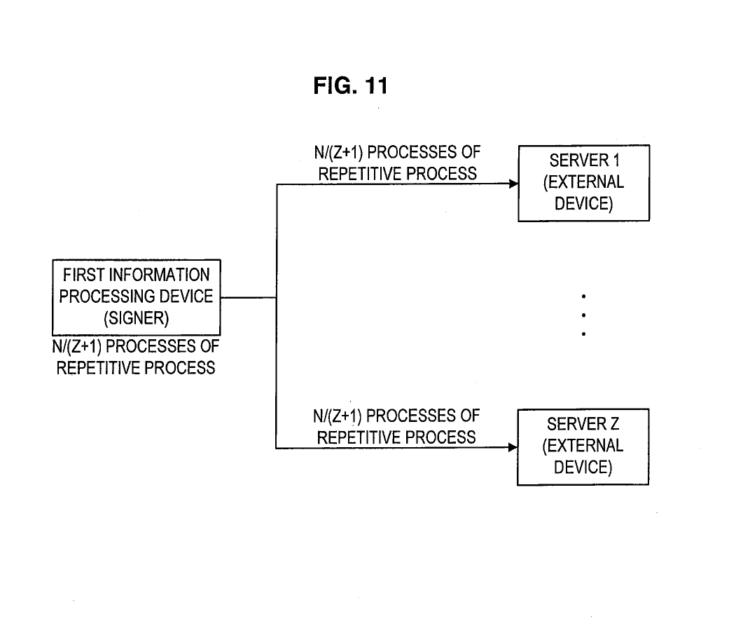

FIG. 11 is a descriptive diagram illustrating another example of the second example of the distribution control process in the first information processing device according to the present embodiment. Herein, FIG. 11 illustrates the example in which the first information processing device according to the present embodiment causes the repetitive process in the process for signature to be distributively performed in Z external devices which are the server 1 to the server Z (Z is an integer equal to or greater than 2) and the device itself. In addition, each of the servers (an example of an external device) and the first information processing device shown in FIG. 11 has a secret key corresponding to the process for signature. The secret key corresponding to the process for signature is given to each of the servers (an example of an external device) through, for example, a user operation by the user of the first information processing device according to the present embodiment.

As illustrated in FIG. 11, when there are Z servers (an example of an external device) that can execute the repetitive process in the process for signature, for example, the first information processing device according to the present embodiment equally divides the repetitive process in which a process is repeated N times for the process for signature into the total number “Z+1” of the number of external devices “Z” and the device itself. Then, the first information processing device according to the present embodiment causes the divided repetitive processes, i.e., N/(Z+1) processes in the repetitive process, to be performed by each of the server 1 to the server Z as illustrated in, for example, FIG. 11. It should be noted that, when N/(Z+1) is not a positive integer, the first information processing device according to the present embodiment adjusts the number of processing times so that the number of processes in the repetitive process to be performed by the server 1 to the server Z and the device itself becomes a positive integer.

As described above, since the repetitive process in the process for signature according to the present embodiment is a process in which an independent process is repeated as described above, the processes in the repetitive process according to the present embodiment do not affect the generated signature data even when each is distributively performed in the server 1 to the server Z and the device itself. In addition, by causing each of the processes in the repetitive process according to the present embodiment to be distributively performed in the server 1 to the server Z and the device itself, the processing amount (amount of computation) of the process for signature according to the present embodiment performed in the first information processing device according to the present embodiment decreases.

Thus, as illustrated in FIG. 11, for example, when the first information processing device according to the present embodiment causes each of the server 1 to the server Z and the device itself to equally perform the processes in the repetitive process according to the present embodiment in the process (1) (distribution control process) and thereby performs the process (2) (execution process) to be described later, the first information processing device according to the present embodiment can speed up the process for signature.

In addition, in the above description, the example in which the first information processing device according to the present embodiment equally divides the repetitive process in the process for signature or authentication into the total number of the external devices and the device itself is shown, but the second example of the distribution control process performed in the first information processing device according to the present embodiment is not limited to the above example.

For example, the first information processing device according to the present embodiment may unequally divide the repetitive process in the process for signature or authentication into the total number of external devices and the device itself. When the process is unequally divided, the first information processing device according to the present embodiment causes some of the divided repetitive process to be performed in the device itself and the remaining divided repetitive process to be performed in the external devices.

Here, the first information processing device according to the present embodiment unequally divides the repetitive process according to the present embodiment, for example, based on the scale of computing resources of the external devices in the same manner as in another example of the distribution control process relating to the first example described above. In addition, the first information processing device according to the present embodiment may further unequally divide the repetitive process according to the present embodiment based on, for example, the scale of a computing resources of the device itself (first information processing device according to the present embodiment).

In addition, the first information processing device according to the present embodiment causes the external devices and the device itself to perform the unequally divided repetitive process so that a larger number of processes in the repetitive process according to the present embodiment are performed in a device (any external device or the device itself), for example, having more computing resources than another.

For example, by causing the plurality of external devices to perform the divided repetitive process so that the repetitive process according to the present embodiment is unequally divided based on the scale of the computing resources of the external device and a larger number of processes of the repetitive process according to the present embodiment are performed in a device (any external device or the device itself) having more computing resources than another, a processing time of the repetitive process according to the present embodiment in the external devices and the device itself can be further shortened.

Note that it is needless to say that the first information processing device according to the present embodiment can unequally divide the repetitive process in the process for signature or authentication based on the total number of external devices and the device itself rather than the computing resources of the external devices and the device itself.

In addition, since the repetitive process in the process for signature or authentication according to the present embodiment is a process in which an independent process is repeated as described above, the processes in the repetitive process according to the present embodiment do not affect the generated signature data or verification data even when they are unequally distributively performed in the external devices and the device itself. In addition, by causing each of the processes in the repetitive process according to the present embodiment to be distributively performed in the external devices and the device itself, the processing amount (amount of computation) of the process for signature or authentication according to the present embodiment performed in the first information processing device according to the present embodiment decreases.

Thus, as described above, for example, even when the first information processing device according to the present embodiment causes the external devices and the device itself to unequally perform the processes in the repetitive process according to the present embodiment in the process (1) (distribution control process) and thereby performs the process (2) (execution process) to be described later, the first information processing device according to the present embodiment can speed up the process for signature and authentication.

### (1-3) Third Example of the Distribution Control Process

In the first example of the distribution control process and the second example of the distribution control process, the example in which the first information processing device according to the present embodiment causes some or all of the repetitive process in the process for signature or authentication to be distributively performed in the external devices by giving the secret keys to the external devices is shown. However, there are circumstances in which giving a secret key to an external device is not desirable during, for example, generation of signature and authentication.

Thus, the first information processing device according to the present embodiment divides the repetitive process according to the present embodiment so that, for example, only a process portion that can be computed without a secret key out of the repetitive process in the process for signature or authentication is computed in an external device. Then, the first information processing device according to the present embodiment causes the divided repetitive process (process portion that can be computed without a secret key) to be performed in the external device. In addition, the first information processing device according to the present embodiment performs the process other than the process portion that can be computed without a secret key out of the repetitive process in the process for signature or authentication in the device itself.

By causing only the portion that can be computed without a secret key to be performed in the external device as described above, for example, the first information processing device according to the present embodiment can cause some processes of the process for signature or authentication to be distributed to the external device without giving a secret key to the external device.

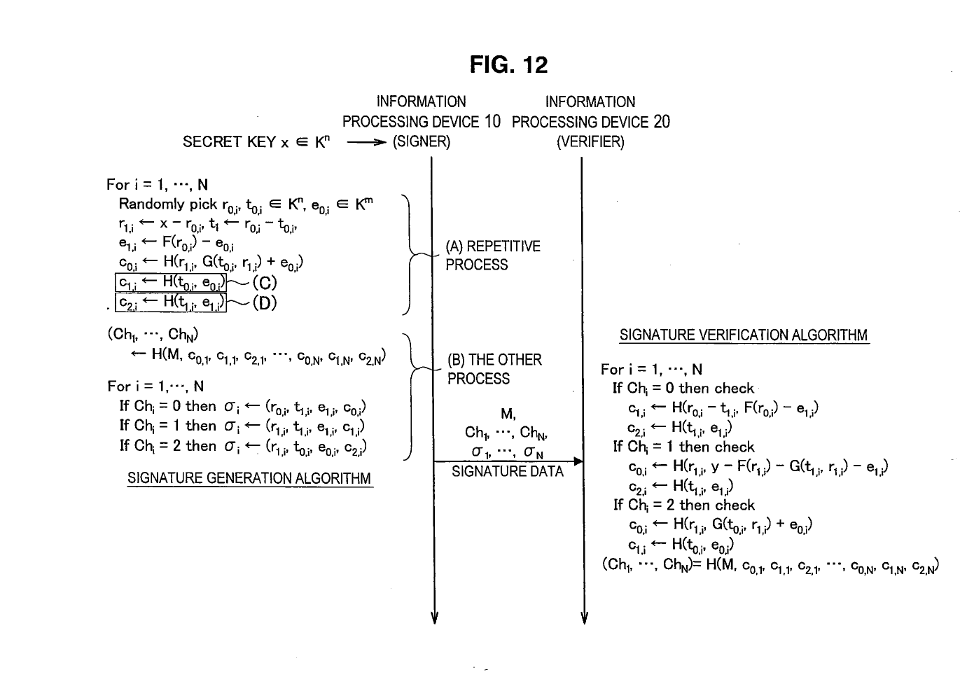

FIG. 12 is a descriptive diagram for describing a third example of the distribution control process in the first information processing device according to the present embodiment. Herein, FIG. 12 illustrates an example of the signature generation algorithm and an example of the signature verification algorithm as an example of the process relating to, for example, the MQ signature scheme disclosed in “Public-Key Identification Schemes Based on Multivariate Quadratic Polynomials” as in FIG. 1.

In a repetitive process indicated by (A) of FIG. 12, for example, the processes indicated by (C) and (D) of FIG. 12 are portions that can be computed without a secret key. Thus, the first information processing device according to the present embodiment divides, for example, the portions indicated by (C) and (D) of FIG. 12 that can be computed without a secret key out of the repetitive process indicated by (A) of FIG. 12, and causes one or two or more external devices to perform the portions indicated by (C) and (D) of FIG. 12.

To be more specific, the first information processing device according to the present embodiment transmits a signature generation command to cause the process portions indicated by (C) and (D) of FIG. 12 including (t_{0,i}, e_{0,i}) and (t_{1,i}, e_{1,i}) to, for example, each of one or two or more external devices so as to cause one or two or more external devices to perform the portion indicated by (C) and (D) of FIG. 12. In addition, the first information processing device according to the present embodiment performs, for example, the process other than the portions indicated by (C) and (D) of FIG. 12 out of the repetitive process indicated by (A) of FIG. 12 in the device itself. Then, the first information processing device according to the present embodiment generates signature data by performing the other process indicated by (B) of FIG. 12 using, for example, the process result acquired from the external devices and the result of the process other than the portions indicated by (C) and (D) of FIG. 12 out of the repetitive process indicated by (A) of FIG. 12 performed in the device itself.

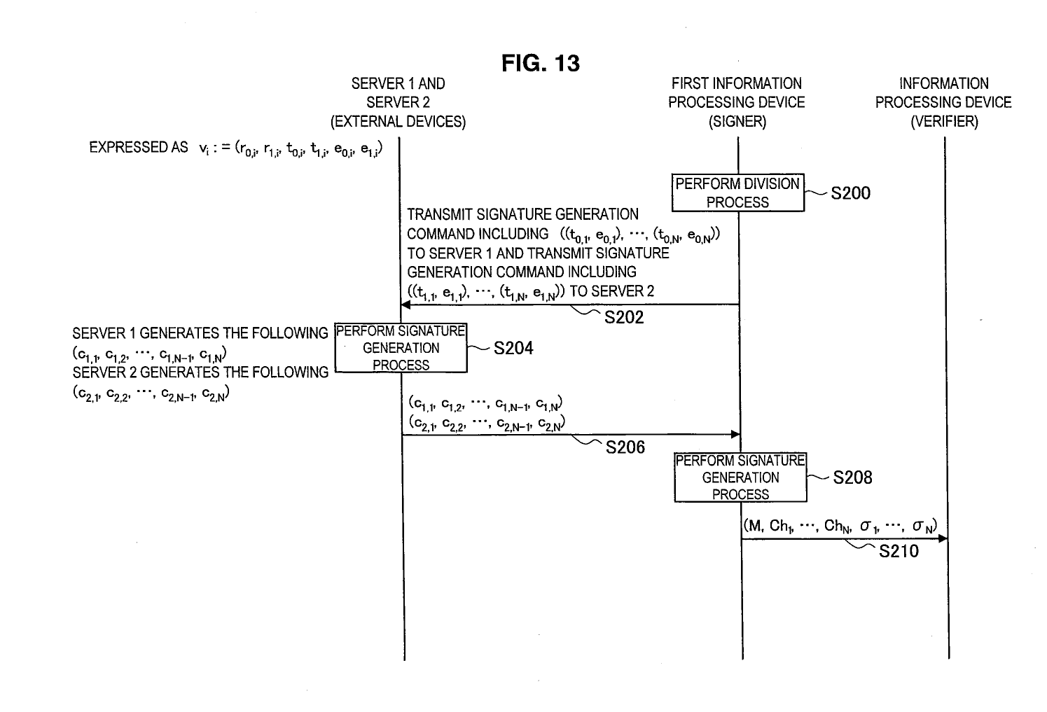

FIG. 13 is a sequence diagram illustrating the third example of the distribution control process in the first information processing device according to the present embodiment. Herein, FIG. 13 illustrates an example in which the first information processing device according to the present embodiment, for example, divides the portions indicated by (C) and (D) of FIG. 12 that can be computed without a secret key out of the repetitive process indicated by (A) of FIG. 12, and causes one or two or more external devices to perform the portions indicated by (C) and (D) of FIG. 12. In addition, in FIG. 13, the processes of Steps S200 and S202 correspond to the process (1) (distribution control process), and the processes of Steps S208 and S210 correspond to the process (2) (execution process) to be described later.

The first information processing device according to the present embodiment, for example, divides the repetitive process in the process for signature into, for example, the portions indicated by (C) and (D) of FIG. 12 that can be computed without a secret key and portions other than the portions that can be computed without a secret key (division process of S200).

After the process of Step S200 is performed, the first information processing device according to the present embodiment transmits a signature generation command according to the result of the process of Step S200 to each of the server 1 and the server 2 (S202) in the same manner as in Step S102 of FIG. 7. To be more specific, the first information processing device according to the present embodiment generates, for example, “((v₁, . . . , v_{N}), (c_{0,1}, c_{0,2}, . . . , c_{0, N-1}, c_{0,N})).” In addition, the first information processing device according to the present embodiment transmits the signature generation command to cause the process of the portion indicated by (C) of FIG. 12 including, for example, “((t_{0,1}, e_{0,1}), . . . , (t_{0,N}, e_{0,N}))” to be performed to the server 1. In addition, the first information processing device according to the present embodiment transmits the signature generation command to cause the process of the portion indicated by (D) of FIG. 12 including, for example, “((t_{1,1}, e_{1,1}), . . . , (t_{1,N}, e_{1,N}))” to be performed to the server 2.

Each of the server 1 and the server 2 that receive the signature generation command transmitted from the first information processing device according to the present embodiment in Step S202 performs the processes of the portions indicated by (C) and (D) of FIG. 12 that can be computed without a secret key in the repetitive process of the process for signature (signature generation process of S204) based on the received signature generation command. To be more specific, the server 1 generates, for example, “(c_{1,1}, c_{1,2}, . . . , c_{1,N-1}, c_{1,N})” based on the signature generation command, and the server 2 generates, for example, “(c_{2,1}, c_{2,2}, . . . , c_{2,N-1}, c_{2,N})” based on the signature generation command

When the process of Step S204 is completed, each of the server 1 and the server 2 transmits the results of the processes based on the signature generation command for the process for signature to the first information processing device according to the present embodiment (S206).

The first information processing device according to the present embodiment that receives the results of the processes based on the signature generation command for the process for signature transmitted from each of the server 1 and the server 2 in Step S206 generates signature data using the received results of the repetitive process in the process for signature (signature generation process of S208). To be more specific, the first information processing device according to the present embodiment, for example, performs a process of excluding the portions indicated by (C) and (D) of FIG. 12 from the repetitive process indicated by (A) of FIG. 12, and generates the signature data by performing the other process indicated by (B) of FIG. 12 using the result of the exclusion process and the received results of the repetitive process in the process for signature.

When the process of Step S208 is completed, the first information processing device according to the present embodiment transmits the generated signature data to an information processing device serving as a verifier that, for example, performs the process of the signature verification algorithm (process for verification) shown in FIG. 12 (S210), in the same manner as in Step S110 of FIG. 7.

When the first information processing device according to the present embodiment causes each of the server 1 and the server 2 to perform the process portions that can be computed without a secret key in the repetitive process according to the present embodiment in the process (1) (distribution control process), the process illustrated in FIG. 13 is performed as, for example, a process of the information processing method according to the present embodiment relating to the process for signature.

Here, as illustrated in FIG. 13, for example, even when the process portions that can be computed without a secret key out of the repetitive process in the process for signature are performed in the external devices, and the portions other than the process portion that can be computed without a secret key out of the repetitive process in the process for signature are performed in the first information processing device itself, the operation does not affect the generated signature data. In addition, by causing some of the processes in the repetitive process according to the present embodiment to be distributively performed in the external devices, the processing amount (amount of computation) of the process for signature or authentication according to the present embodiment performed in the first information processing device according to the present embodiment decreases.

Thus, as described above, for example, even when the first information processing device according to the present embodiment causes the external devices to perform some of the processes in the repetitive process according to the present embodiment in the process (1) (distribution control process) and thereby performs the process (2) (execution process) to be described later, the first information processing device according to the present embodiment can speed up the process for signature or authentication.

The first information processing device according to the present embodiment performs, for example, the process of the first example described above to the process of the third example described above as the process (1) (distribution control process). Note that it is needless to say that the process (1) (distribution control process) according to the present embodiment is not limited to the process of the first example described above to the process of the third example described above.

### (2) Execution Process

The first information processing device according to the present embodiment performs the process for signature or authentication using processing results of external devices that perform processes in a distributed manner in the process (1) (distribution control process) described above.

To be more specific, the first information processing device according to the present embodiment performs processes other than the repetitive process according to the present embodiment in the process for signature or authentication using, for example, the processing results of the external devices, and thereby generates signature data or certification data. In addition, the first information processing device according to the present embodiment transmits the generated signature data or certification data to, for example, an information processing device serving as a verifier (information processing device that performs a process for verification).

The first information processing device according to the present embodiment performs, for example, the process (1) (distribution control process) described above and the process (2) (execution process) as processes of the information processing method according to the present embodiment for the process for signature or authentication.

Here, since the repetitive process in the process for signature or authentication according to the present embodiment is a process in which an independent process is repeated, even when some or all of the processes in the repetitive process according to the present embodiment are distributively performed in the external devices in the process (1) (distribution control process) described above, the operation does not affect the generated signature data or certification data. In addition, by causing some or all of the processes in the repetitive process according to the present embodiment to be distributively performed in the external devices, the processing amount (amount of computation) of the process for signature according to the present embodiment performed in the first information processing device according to the present embodiment decreases.

Thus, by performing the process (1) (distribution control process) described above and the process (2) (execution process) as, for example, processes of the information processing method according to the present embodiment relating to the process for signature or authentication, the first information processing device according to the present embodiment can speed up the process for signature.

### [2-2] Process of the Information Processing Method According to the Present Embodiment Relating to the Process for Verification

Next, a process of the information processing method according to the present embodiment relating to the process for verification will be described. Hereinafter, description will be provided exemplifying that the process of the information processing method according to the present embodiment relating to the process for verification is performed by a second information processing device according to the present embodiment.

### (I) Distribution Control Process

The second information processing device according to the present embodiment divides, for example, signature data or certification data verified from the process for verification including a repetitive process. In addition, the second information processing device according to the present embodiment causes the repetitive process in the process for verification with regard to the divided signature data or certification data to be distributively performed in one or two external devices.

### (I-1) First Example of Distribution Control Process

The second information processing device according to the present embodiment causes the repetitive process in the process for verification with regard to the divided signature data or certification data, for example, to be distributively performed in a plurality of external devices.

To be more specific, the second information processing device according to the present embodiment, for example, equally divides the signature data or certification data into the number of external devices. Then, the second information processing device according to the present embodiment causes the repetitive process in the process for verification with regard to the divided signature data or certification data, for example, to be performed in the plurality of external devices.

It should be noted that, when the signature data or certification data is equally divided into the number of external devices, for example, there may be a case in which it is difficult to divide the signature data or certification data completely equally into the number of external devices depending on the number of repetitions of the repetitive process in the process for verification according to the present embodiment. As described above, when it is difficult to divide the signature data or certification completely equally into the number of external devices, the second information processing device according to the present embodiment adjusts the data amount of the signature data or the certification data to be allocated to each of the external devices so that, for example, the difference of data amounts of the signature data or the certification data to be distributively processed in each of the external devices falls within a set range.

In other words, “equally dividing the signature data or the certification data into the number of external devices” according to the present embodiment also includes adjusting the data amount of the signature data or the certification data to be allocated to each of the external devices so that, for example, the difference of data amounts of the signature data or the certification data to be distributively processed in each of the external devices falls within a set range.

Here, the second information processing device according to the present embodiment causes the repetitive process in the process for verification with regard to the divided signature data or certification data to be performed in the plurality of external devices in the same manner as the processes in the first information processing device according to the present embodiment illustrated in, for example, FIG. 6 and FIG. 8.

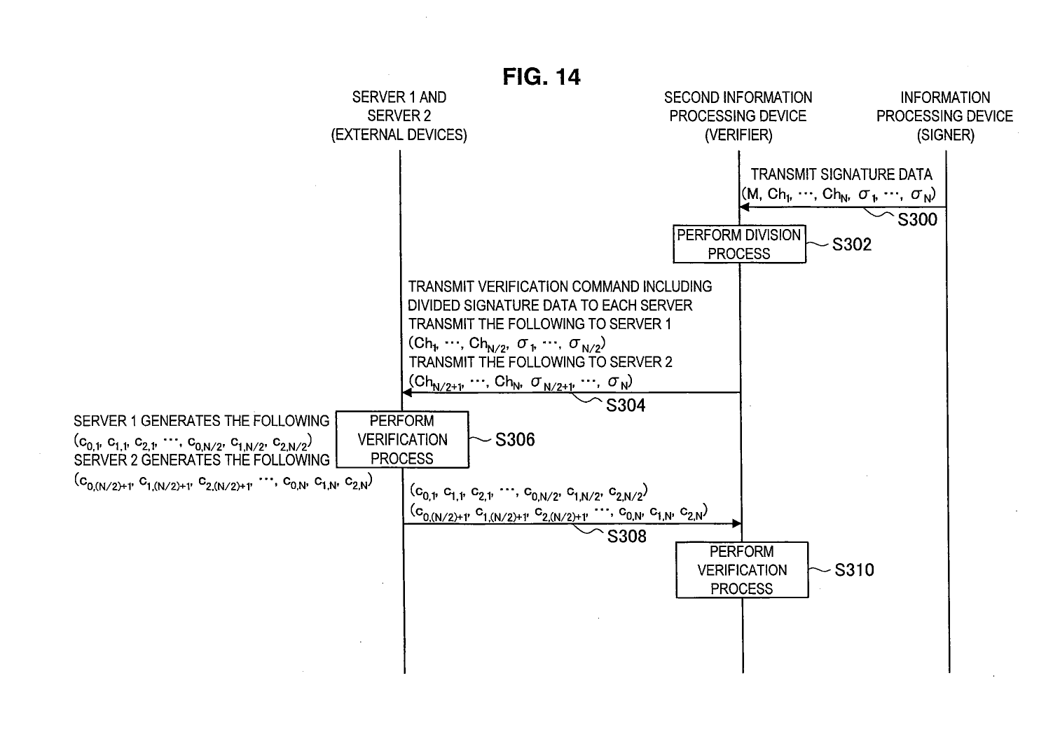

FIG. 14 is a sequence diagram illustrating an example of the process of the information processing method according to the present embodiment relating to the process for verification. Herein, FIG. 14 illustrates the example of the process when the second information processing device according to the present embodiment causes each of the server 1 and the server 2 to perform the repetitive process in the process for verification with regard to the equally divided signature data or certification data. In addition, FIG. 14 illustrates the example of the process when the second information processing device according to the present embodiment performs the process of the signature verification algorithm (process for verification) illustrated in, for example, FIG. 1 and FIG. 3. In addition, in FIG. 14, the processes of Steps S302 and S304 correspond to the process (I) (distribution control process), and the process of Step S310 corresponds to a process (II) (verification process) to be described later.

When the signature data transmitted from an information processing device serving as a signer (information processing device performing the process for signature) is received (S300), the second information processing device according to the present embodiment divides the received signature data (division process of S302).

To be specific, the second information processing device according to the present embodiment divides, for example, the received signature data into two equal parts of “(Ch₁, . . . , Ch_{N/2}, σ₁, . . . , σ_{N/2})” and “(Ch_{N/2+1}, . . . , Ch_{N}, σ_{N/2+1}, . . . , σ_{N}).” It should be noted that, when it is difficult to divide the signature data equally completely into the number of external devices, the second information processing device according to the present embodiment adjusts the data amount of the signature data to be allocated to each of the external devices so that difference of data amounts of the signature data or the certification data to be distributively processed in each of the external devices falls within a set range.

After the process of Step S302 is performed, the second information processing device according to the present embodiment transmits a verification command according to the result of the process of Step S302 to each of the server 1 and the server 2 (S304). The second information processing device according to the present embodiment transmits the verification command by performing communication with the server 1 and the server 2 via the communication unit provided in, for example, the device itself (the second information processing device according to the present embodiment) or an external communication device.

Here, the verification command according to the present embodiment is a data serving as a trigger for causing the external devices to perform the repetitive process in the process for verification. The verification command according to the present embodiment includes, for example, the divided signature data or certification data.

To be specific, in Step S304, the second information processing device according to the present embodiment transmits the verification command including, for example, the signature data “(Ch₁, . . . , Ch_{N/2}, σ₁, . . . , σ_{N/2})” divided in Step S302 to the server 1. In addition, in Step S304, the second information processing device according to the present embodiment transmits the verification command including, for example, the signature data “(Ch_{N82+1}, . . . , Ch_{N}, σ_{N/2+1}, . . . , σ_{N})” divided in Step S302 to the server 2.

Each of the server 1 and the server 2 that has received the verification command transmitted from the second information processing device according to the present embodiment in Step S304 performs the repetitive process in the process for verification with regard to the divided signature data based on the received verification command (verification process of S306). To be specific, each of the server 1 and the server 2 performs the repetitive process indicated by, for example, (A) of FIG. 3.

When the process of S306 is completed, each of the server 1 and the server 2 transmits the result of the repetitive process in the process for verification to the second information processing device according to the present embodiment (S308).

The second information processing device according to the present embodiment that has received the result of the repetitive process in the process for verification transmitted from each of the server 1 and the server 2 in Step S308 verifies the signature data using the received result of the repetitive process in the process for verification (verification process of S310).

The second information processing device according to the present embodiment verifies the signature data by performing, for example, the other process indicated by (B) of FIG. 3. To be specific, the second information processing device according to the present embodiment, for example, performs a hash operation in the other process indicated by (B) of FIG. 3, and then performs a comparison operation on a hash value obtained from the hash operation and a challenge Chᵢ (i=1, . . . , N) of the received signature data. Since the value of the comparison operation corresponds to a verification result of the signature data, the second information processing device according to the present embodiment can thereby verify the signature data.

When second information processing device according to the present embodiment causes the external devices to perform the repetitive process in the process for verification with regard to the equally divided signature data in, for example, the process (I) (distribution control process), for example, the process illustrated in FIG. 14 is performed as a process of the information processing method according to the present embodiment relating to the process for verification.

Here, as described above, since the repetitive process in the process for verification according to the present embodiment is a process in which an independent process is repeated, for example, a process in the repetitive process according to the present embodiment performed on one divided piece of signature data does not affect another process in the repetitive process according to the present embodiment performed on the other divided piece of signature data. In other words, even when the second information processing device according to the present embodiment causes the processes in the repetitive process performed on the divided signature data to be distributively performed in one or two or more external devices, the operation does not affect the result of the process for verification according to the present embodiment.

In addition, by causing the repetitive process in the process for verification with regard to the divided signature data to be distributively performed in one or two or more external devices, the processing amount (amount of computation) of the process for verification according to the present embodiment performed in the second information processing device according to the present embodiment decreases.

Thus, as illustrated in FIG. 14, for example, when the second information processing device according to the present embodiment equally divides signature data into the number of external devices and causes the external devices to perform the repetitive process in the process for verification with regard to the divided signature data in the process (I) (distribution control process) and thereby performs the process (II) (verification process) to be described later, the second information processing device according to the present embodiment can speed up the process for verification.

It should be noted that the first example of the distribution control process in the second information processing device according to the present embodiment is not limited to the example illustrated in FIG. 14.

For example, the second information processing device according to the present embodiment may unequally divide signature data or certification data into the number of external devices. When the data is unequally divided, the second information processing device according to the present embodiment causes the plurality of external devices to perform all processes of the repetitive process in the process for verification with regard to the divided signature data or certification data.

Here, the second information processing device according to the present embodiment causes the plurality of external devices to perform the repetitive process in the process for verification with regard to the divided signature data or certification data based on the scale of computing resources of the external devices that can execute the repetitive process in the process for verification in the same manner as, for example, in the process of the first information processing device according to the present embodiment as illustrated in FIG. 9.

To be specific, the second information processing device according to the present embodiment unequally divides signature data or certification data into the number of external devices based on, for example, the scale of computing resources of the external devices. Then, the second information processing device according to the present embodiment causes the plurality of external devices to perform the repetitive process in the process for verification with regard to the divided signature data or certification data so that an external device having more computing resources than another processes the divided signature data or certification data piece having a larger data amount than another.

As described above, for example, by causing the plurality of external devices to perform the repetitive process in the process for verification with regard to the divided signature data or certification data so that an external device having more computing resources than another processes the divided signature data or certification data piece having a larger data amount than another, a processing time of the repetitive process according to the present embodiment in the external devices can be further shortened.

Note that it is needless to say that the second information processing device according to the present embodiment can unequally divide the signature data or certification data based on the number of external devices rather than the computing resources of the external devices.

As described above, since the repetitive process in the process for verification according to the present embodiment is a process in which an independent process is repeated, even when the signature data or certification data is unequally divided into the number of external devices, for example, the operation does not affect the verification result of the signature data or certification data. In addition, by causing the repetitive process in the process for verification with regard to the divided signature data to be distributively performed in one or two or more external devices, the processing amount (amount of computation) of the process for verification according to the present embodiment performed in the second information processing device according to the present embodiment decreases.

Thus, as described above, when the second information processing device according to the present embodiment unequally divides the signature data or certification data into the number of external devices and causes the external devices to perform the repetitive process in the process for verification with regard to the divided signature data in the process (I) (distribution control process) and thereby performs the process (II) (verification process) to be described later, the second information processing device according to the present embodiment can speed up the process for verification.

### (1-2) Second Example of Distribution Control Process

In the first example of the distribution control process described above, the example in which the second information processing device according to the present embodiment causes all processes of the repetitive process in the process for verification to be distributively performed in the plurality of external devices is shown. However, the process of the information processing method according to the present embodiment relating to the process for verification is not limited to causing all processes of the repetitive process according to the present embodiment to be distributively performed in a plurality of external devices.

For example, the second information processing device according to the present embodiment may cause the repetitive process in the process for verification with regard to the divided signature data or certification data to be distributively performed in one or two or more external devices and the device itself (the second information processing device according to the present embodiment, to be more specific, for example, a processing unit to be described below, and the same applies hereinafter).

To be more specific, the second information processing device according to the present embodiment equally divides signature data or certification data into, for example, the total number of external devices and the device itself. Then, the second information processing device according to the present embodiment causes the repetitive process in the process for verification with regard to the divided signature data or certification data to be performed in the external devices and the device itself.

It should be noted that, when the signature data or certification data is equally divided into the total number of external devices and the device itself, for example, there is a case in which it is difficult to divide the signature data or certification data completely equally into the total number of external devices and the device itself depending on, for example, the number of repetitions of the repetitive process in the process for verification according to the present embodiment. When it is difficult to divide the signature data or certification data completely equally into the total number of external devices and the device itself as described above, the second information processing device according to the present embodiment adjusts the data amount of the signature data or certification data to be allocated to each of the external devices so that, for example, the difference of data amounts of the signature data or the certification data to be distributively processed in each of the external devices falls within a set range.

In other words, “equally dividing the signature data or the certification data into the total number of external devices and the device itself” according to the present embodiment also includes adjusting the data amount of the signature data or the certification data to be allocated to each of the external devices so that, for example, the difference of data amounts of the signature data or the certification data to be distributively processed in each of the external devices falls within a set range.

Here, the second information processing device according to the present embodiment causes the repetitive process in the process for verification with regard to the divided signature data or certification data to be performed in one or two or more external devices and the device itself in the same manner as in, for example, the process of the first information processing device according to the present embodiment illustrated in FIGS. 10 and 11.

As described above, since the repetitive process in the process for verification according to the present embodiment is a process in which an independent process is repeated, for example, a process in the repetitive process according to the present embodiment performed on one divided piece of signature data or certification data does not affect another process in the repetitive process according to the present embodiment performed on the other divided piece of signature data or certification data. In other words, even when the second information processing device according to the present embodiment causes the processes in the repetitive process performed on the divided signature data or certification data to be distributively performed in one or two or more external devices and the device itself, the operation does not affect the result of the process for verification according to the present embodiment.

In addition, by causing the repetitive process in the process for verification with regard to the divided signature data or certification data to be distributively performed in one or two or more external devices and the device itself, the processing amount (amount of computation) of the process for verification according to the present embodiment performed in the second information processing device according to the present embodiment decreases.

Thus, as described above, for example, when the second information processing device according to the present embodiment equally divides the signature data or certification data into the total number of external devices and the device itself and causes the external devices and the device itself to perform the repetitive process in the process for verification with regard to the divided signature data or certification data in the process (I) (distribution control process) and thereby performs the process (II) (verification process) to be described later, the second information processing device according to the present embodiment can speed up the process for verification.

It should be noted that, in the above description, the example in which the second information processing device according to the present embodiment equally divides the repetitive process in the process for verification with regard to the divided signature data or the certification data into the total number of the external devices and the device itself is shown, but the second example of the distribution control process in the second information processing device according to the present embodiment is not limited to the above example.

For example, the second information processing device according to the present embodiment may unequally divide the repetitive process in the process for verification with regard to the divided signature data or certification data into the total number of the external devices and the device itself. When the data is unequally divided, the second information processing device according to the present embodiment causes the repetitive process in the process for verification with regard to the divided signature data or certification data to be performed in the external devices and the device itself.

Here, the second information processing device according to the present embodiment unequally divides the signature data or the certification data based on the scale of computing resources of the external devices that can execute the repetitive process in the process for verification, for example, in the same manner as in the other example of the first example of the distribution control process described above. In addition, the second information processing device according to the present embodiment may unequally divide the signature data or the certification data based further on the scale of the computing resources of the device itself (the second information processing device according to the present embodiment).

In addition, the second information processing device according to the present embodiment causes the external devices and the device itself to perform the repetitive process in the process for verification with regard to the divided signature data or certification data so that the divided signature data or certification data having a larger data amount than another is performed in a device (any external device or the device itself), for example, having more computing resources than another.

By, for example, unequally dividing the signature data or certification data according to the present embodiment and causing the external devices and the device itself to perform the repetitive process in the process for verification with regard to the divided signature data or certification data so that the divided signature data or certification data having a larger data amount than another is performed in a device (any external device or the device itself) having more computing resources than another as described above, a processing time of the repetitive process according to the present embodiment in the external devices and the device itself can be further shortened.

Note that it is needless to say that the second information processing device according to the present embodiment can unequally divide the signature data or the certification data based on the number of external devices rather than the computing resources of the external devices.

In addition, as described above, since the repetitive process in the process for verification according to the present embodiment is a process in which an independent process is repeated, even when the signature data or the certification data is unequally divided into the number of external devices, the operation does not affect the verification result of the signature data or the certification data. In addition, by causing the repetitive process in the process for verification with regard to the divided signature data or certification data to be distributively performed in one or two or more external devices and the device itself, the processing amount (amount of computation) of the process for verification according to the present embodiment performed in the second information processing device according to the present embodiment decreases.

Thus, as described above, for example, when the second information processing device according to the present embodiment unequally divides the signature data or certification data into the number of external devices and causes the external devices and the device itself to perform the repetitive process in the process for verification with regard to the divided signature data or certification data in the process (I) (distribution control process) and thereby performs the process (II) (verification process) to be described later, the second information processing device according to the present embodiment can speed up the process for verification.

### (I-3) Third Example of the Distribution Control Process

In the first example of the distribution control process and the second example of the distribution control process, the example in which the second information processing device according to the present embodiment divides the signature data or the certification data, and causes the repetitive process in the process for verification with regard to the divided signature data or certification data to be performed in the external devices is shown, however, the process (I) (distribution control process) in the process of the information processing method according to the present embodiment relating to the process for verification is not limited to the above example.

For example, the second information processing device according to the present embodiment may divide processes in the repetitive process in the process for verification including the repetitive process for verifying signature data or certification data, and cause the divided processes to be performed in one or two external devices.

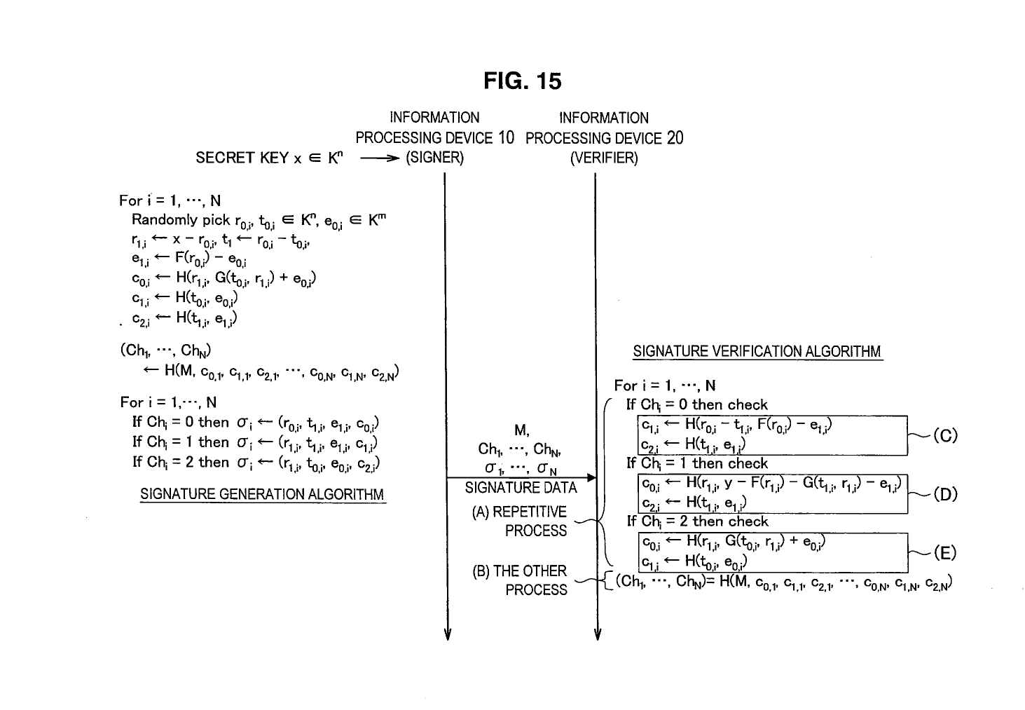

FIG. 15 is a descriptive diagram for describing a third example of the distribution control process of the second information processing device according to the present embodiment. Herein, FIG. 15 illustrates an example of a signature generation algorithm and an example of a signature verification algorithm as an example of the process relating to the MQ signature scheme disclosed in, for example, “Public-Key Identification Schemes Based on Multivariate Quadratic Polynomials” in the same manner as in FIG. 1.

In the repetitive process indicated by (A) of FIG. 15, for example, a hash computation is executed two times each in the processes indicated by (C) to (E) of FIG. 15 that are partial processes in the repetitive process. Thus, the second information processing device according to the present embodiment divides some or all of the two hash computations in the processes indicated by (C) to (E) of FIG. 15 that are partial processes in the repetitive process, and causes the processes to be distributively performed in one or two or more external devices.

Here, when all of the two hash computations in the processes indicated by (C) to (E) of FIG. 15 are caused to be performed in one or two or more external devices, for example, the second information processing device according to the present embodiment verifies signature data by performing the other process indicated by (B) of FIG. 15 using, for example, the processing results of the processes in the repetitive process obtained by the external devices.

In addition, some of the two hash computations in the processes indicated by (C) to (E) of FIG. 15 are caused to be performed in the external devices, for example, the second information processing device itself according to the present embodiment performs the remaining processes of the two hash computations. Then, the second information processing device according to the present embodiment verifies the signature data by performing the other process indicated by (B) of FIG. 15 using the processing results of the processes in the repetitive process obtained by the external devices, and the processing result of the process in the repetitive process obtained by the device itself.

As described above, since the repetitive process in the process for verification according to the present embodiment is a process in which an independent process is repeated, even when the processes in the repetitive process in the process for verification are divided, for example, the operation does not affect the verification result of the signature data or the certification data. In addition, by causing the processes in the repetitive process in the process for verification with regard to the divided signature data or certification data to be distributively performed in one or two or more external devices or external devices and the device itself, the processing amount (amount of computation) of the process for verification according to the present embodiment performed in the second information processing device according to the present embodiment decreases.

Thus, as described above, when the second information processing device according to the present embodiment divides the processes in the repetitive process in the process for verification including the repetitive process for verifying the signature data or the certification data, and causes the divided processes to be distributively performed in one or two external devices in the process (I) (distribution control process), and thereby performs the process (II) (verification process) to be described later, the second information processing device according to the present embodiment can speed up the process for verification.

The second information processing device according to the present embodiment performs, for example, the process of the first example to the process of the third example as the process (I) (distribution control process). Note that it is needless to say that the process (I) (distribution control process) according to the present embodiment is not limited to the process of the first example to the process of the third example.

### (II) Verification Process

The second information processing device according to the present embodiment verifies the signature data or the certification data using the processing results obtained by the external devices that are caused to perform processes in a distributed manner in the process (I) (distribution control process).

To be more specific, when the signature data shown in FIG. 3 is verified, for example, the second information processing device according to the present embodiment performs, for example, the hash operation in the other process indicated by (B) of FIG. 3, and performs a comparison operation of a hash value obtained from the hash operation and a challenge Chi (i=1, . . . , N) of the received signature data, and thereby obtains a verification result of the signature data. In addition, when the certification data shown in FIG. 4 is verified, for example, the second information processing device according to the present embodiment obtains a verification result of the certification data after obtaining, for example, the result of the repetitive process indicated by (C) of FIG. 4.

It should be noted that the process (II) (verification process) in the second information processing device according to the present embodiment is not limited to the above example.

For example, the second information processing device according to the present embodiment may transmit the verification result of the signature data or the certification data to external devices that will perform processes in a distributed manner. The second information processing device according to the present embodiment transmits the verification result of the signature data or the certification data to a communication unit (to be described below) provided in the device itself (the second information processing device according to the present embodiment) or an external communication device.

As described above, for example, when the second information processing device according to the present embodiment transmits the verification result of the signature data or the certification data to one or two or more external devices that will perform the processes in a distributed manner, the external devices that receive the verification result can be regarded as verifiers in the present embodiment. Thus, when the second information processing device according to the present embodiment transmits the verification result of the signature data or the certification data to one or two or more external devices that will perform the processes in a distributed manner, verification by a plurality of verifiers is possible in the present embodiment by the second information processing device according to the present embodiment and one or two or more external devices that receive the verification result.

In addition, when the second information processing device according to the present embodiment transmits the verification result of the signature data or the certification data to one or two or more external devices that will perform the processes in a distributed manner as described above, for example, a device serving as an authenticator can perform authentication between devices serving as a plurality of verifiers with a processing amount of one process for authentication. Furthermore, each of the devices serving as a verifier can execute the process for verification with a processing amount of “1/(the number of devices serving as verifiers).”

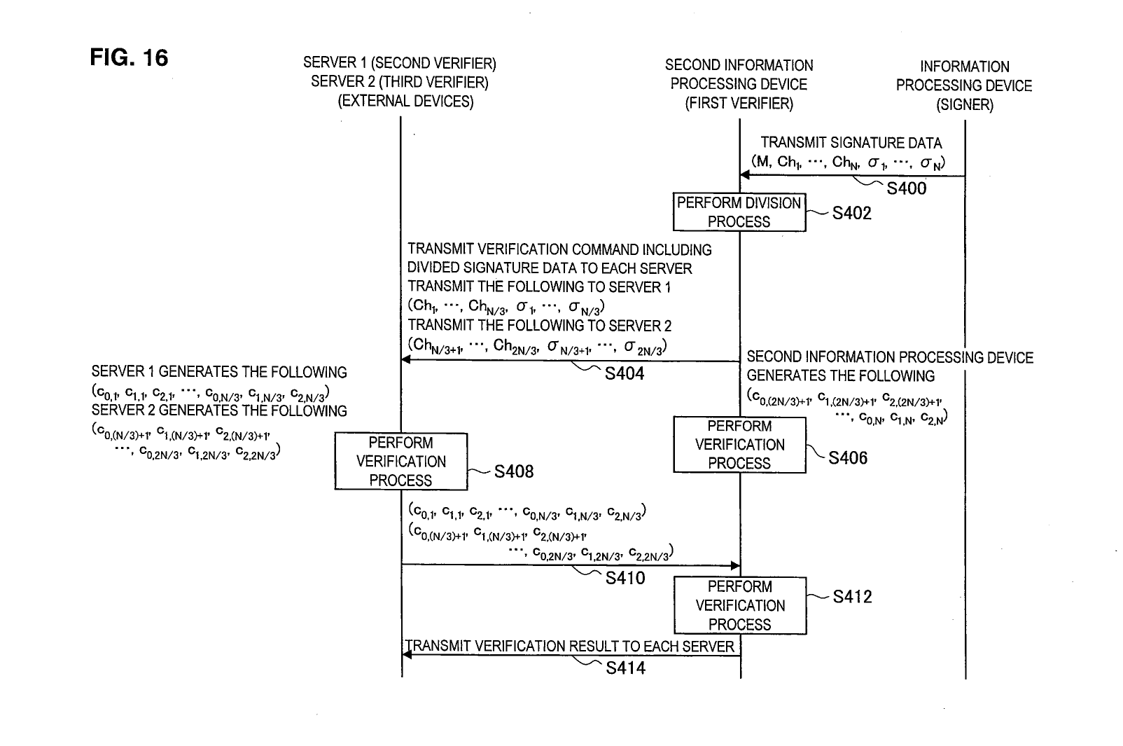

FIG. 16 is a sequence diagram illustrating another example of the process of the information processing method according to the present embodiment relating to the process for verification. Herein, FIG. 16 illustrates an example of the process when the second information processing device according to the present embodiment causes the repetitive process in the process for verification with regard to the divided signature data or certification data to be performed in each of the server 1, the server 2, and the device itself. In addition, FIG. 16 illustrates an example of the process when the second information processing device according to the present embodiment performs, for example the process of the signature verification algorithm (process for verification) illustrated in FIGS. 1 and 3. In addition, in FIG. 16, the processes of Steps S402 and S404 correspond to the process (I) (distribution control process), and the processes of Steps S412 and S414 correspond to the process (II) (verification process).

When signature data transmitted from an information processing device serving as a signer (an information processing device that performs the process for signature) is received (S400), the second information processing device according to the present embodiment divides the received signature data into three parts (division process of S402).

After the process of Step S402 is performed, the second information processing device according to the present embodiment transmits a verification command according to the result of the process of Step S402 to each of the server 1 and the server 2 (S404) in the same manner as in Step S304 shown in FIG. 14.

In addition, after the process of Step S402 is performed, the second information processing device according to the present embodiment performs the repetitive process in the process for verification on remaining divided signature data that will not be processed in the server 1 and the server 2 out of the divided signature data (verification process of S406). To be more specific, the second information processing device according to the present embodiment performs the repetitive process indicated by, for example, (A) of FIG. 3.

Each of the server 1 and the server 2 that has received the verification command transmitted from the second information processing device according to the present embodiment in Step S404 performs the repetitive process in the process for verification with regard to the divided signature data based on the received verification command (verification process of S408) in the same manner as in Step S306 shown in FIG. 14.

When the process of Step S408 is completed, each of the server 1 and the server 2 transmits the result of the repetitive process in the process for verification to the second information processing device according to the present embodiment (S410) in the same manner as in Step S308 shown in FIG. 14.

The second information processing device according to the present embodiment that receives the result of the repetitive process in the process for verification transmitted from each of the server 1 and the server 2 in Step S410 verifies the signature data using the received result of the repetitive process in the process for verification and the result of the repetitive process in the process for verification obtained in Step S406 (verification process of S412) in the same manner as in Step S310 shown in FIG. 14.

Then, the second information processing device according to the present embodiment transmits the verification result to each of the server 1 and the server 2 (S414).

When the second information processing device according to the present embodiment causes the repetitive process in the process for verification with regard to the divided signature data to be performed in, for example, the external devices and the device itself in the process (I) (distribution control process), for example, the process illustrated in FIG. 16 is performed as the process of the information processing method according to the present embodiment relating to the process for verification.

Here, as described above, since the repetitive process in the process for verification according to the present embodiment is a process in which an independent process is repeated, for example, a process of the repetitive process according to the present embodiment with regard to one divided signature data piece does not affect another process of the repetitive process according to the present embodiment with regard to the other divided signature data piece. In other words, even when the second information processing device according to the present embodiment causes the processes of the repetitive process with regard to the divided signature data to be distributively performed in the servers (an example of an external device) and the device itself, the operation does not affect the result of the process for verification according to the present embodiment.

In addition, by causing the repetitive process in the process for verification with regard to the divided signature data to be distributively performed in the servers (an example of an external device) and the device itself, the processing amount (amount of computation) of the process for verification according to the present embodiment performed in the second information processing device according to the present embodiment decreases.

Thus, as illustrated in FIG. 16, when the second information processing device according to the present embodiment divides the signature data into the total number of the servers (an example of an external device) and the device itself and cases the repetitive process in the process for verification with regard to the divided signature data to be performed in the servers and the device itself in the process (I) (distribution control process), and thereby performs the process (II) (verification process), for example, the second information processing device according to the present embodiment can speed up the process for verification.

In addition, when the second information processing device according to the present embodiment transmits the verification result to each of the servers (an example of an external device) that will perform the process in a distributed manner, verification by the plurality of verifiers including the second information processing device according to the present embodiment and each of the servers that receive the verification result is possible.

In addition, when the second information processing device according to the present embodiment transmits the verification result to each of the servers (an example of an external device) that will perform the process in a distributed manner, the device serving as an authenticator can perform authentication with the devices serving as the plurality of verifiers with the processing amount of one process for authentication. Furthermore, each device serving as a verifier can execute the process for verification with the processing amount of “1/(the number of devices serving as verifiers).”

The second information processing device according to the present embodiment performs, for example, the process (I) (distribution control process) and the process (II) (verification process) as the process of the information processing method according to the present embodiment relating to the process for verification.

Here, since the repetitive process in the process for verification according to the present embodiment is a process in which an independent process is repeated, for example, a process of the repetitive process according to the present embodiment with regard to one divided signature data piece does not affect another process of the repetitive process according to the present embodiment with regard to another divided signature data piece. In other words, even when second information processing device according to the present embodiment causes the processes of the repetitive process with regard to the divided signature data or certification data to be distributively performed in the external devices, the operation does not affect the result of the process for verification according to the present embodiment.

In addition, by causing the repetitive process in the process for verification with regard to the divided signature data or certification data to be distributively performed in the external devices, the processing amount (amount of computation) of the process for verification according to the present embodiment performed in the second information processing device according to the present embodiment decreases.

Therefore, for example, by performing the process (I) (distribution control process) and the process (II) (verification process) as the process of the information processing method according to the present embodiment relating to the process for verification, the second information processing device according to the present embodiment can speed up the process for verification.

### (Information Processing Devices According to the Present Embodiment)

Next, each configuration example of the first information processing device according to the present embodiment (an information processing device that performs the process of the information processing method according to the present embodiment relating to the process for signature or authentication) and the second information processing device according to the present embodiment (an information processing device that performs the process of the information processing method according to the present embodiment relating to the process for verification) will be described.

### [1] First Information Processing Device (Device Serving as a Signer or an Authenticator)

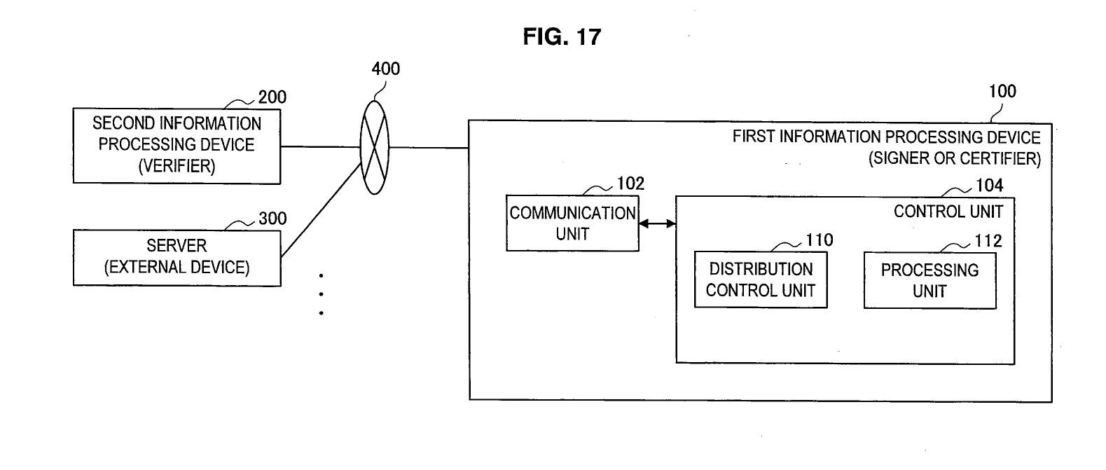

FIG. 17 is a block diagram illustrating a configuration example of the first information processing device 100 according to the present embodiment. FIG. 17 illustrates the second information processing device 200 serving as a verifier and a server 300, and the like which are external devices according to the present embodiment as well.

The first information processing device 100 and the second information processing device 200, and the first information processing device 100 and the server 300, and the like perform communication via, for example, a network 400 (or a direct manner). Here, as the network 400 according to the present embodiment, for example, there are a wired network such as a LAN (Local Area Network) or a WAN (Wide Area Network), a wireless network such as a wireless LAN (WLAN: Wireless Local Area Network), or a wireless WAN via base stations (WWAN: Wireless Wide Area Network), the Internet using communication protocols such as TCP/IP (Transmission Control Protocol/Internet Protocol), or the like.

The first information processing device 100 includes, for example, a communication unit 102 and a control unit 104.

In addition, the first information processing device 100 may include, for example, a ROM (Read Only Memory, not illustrated), a RAM (Random Access Memory, not illustrated), a storage unit (not illustrated), an operation unit (not illustrated) which a user can operate, a display unit (not illustrated) on which various screens can be displayed, and the like. In the first information processing device 100, the constituent elements are connected to each other via, for example, a bus serving as a data transmission path.

Here, the ROM (not illustrated) stores programs used by the control unit 104 and control data such as operation parameters. The RAM (not illustrated) temporarily stores programs executed by the control unit 104, and the like.

The storage unit (not illustrated) is a storing section included in the first information processing device 100, and stores various kinds of data, for example, applications. In addition, the storage unit (not illustrated) includes an area having an anti-tampering property, and stores key data such as a secret key and the like therein. It should be noted that key data such as a secret key and the like may be stored in an arbitrary storage medium having the anti-tampering property. Here, as the storage unit (not illustrated), for example, there are a magnetic recording medium such as a hard disk, a non-volatile memory such as a flash memory, and the like. In addition, the storage unit (not illustrated) may be attachable to or detachable from the first information processing device 100.

In addition, as the operation unit (not illustrated), there is an operation input device to be described later, and as the display unit (not illustrated), there is a display device to be described later.

### [Hardware Configuration Example of the First Information Processing Device 100]

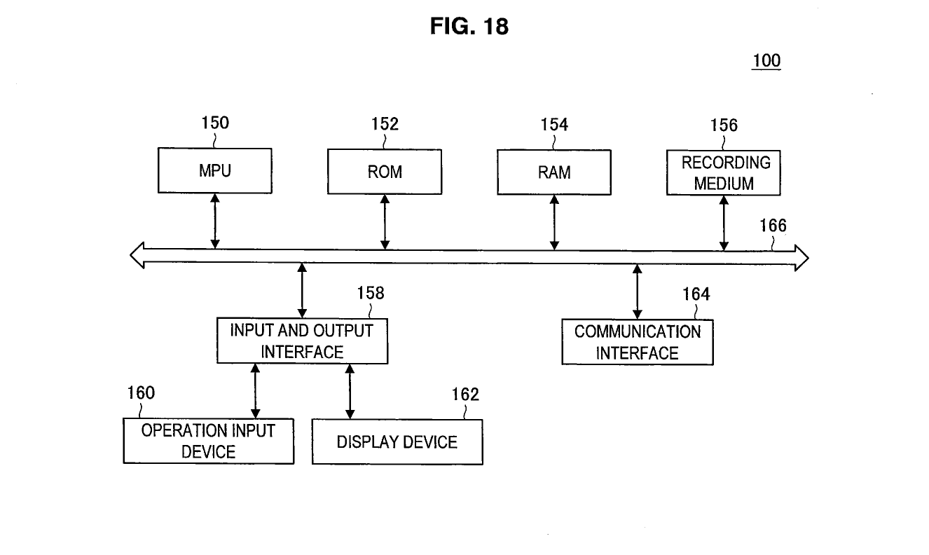

FIG. 18 is an illustrative diagram showing an example of a hardware configuration of the first information processing device 100 according to the present embodiment. The first information processing device 100 includes, for example, an MPU 150, a ROM 152, a RAM 154, a recording medium 156, an input and output interface 158, an operation input device 160, a display device 162, and a communication interface 164. In addition, in the first information processing device 100, the constituent elements are connected to each other via, for example, a bus 166 serving as a data transmission path.

The MPU 150 is configured as, for example, an MPU (Micro Processing Unit), various processing circuits, and the like, and functions as the control unit 104 that controls the entire first information processing device 100. In addition, the MPU 150 serves as, for example, a distribution control unit 110 and a processing unit 112 to be described later in the first information processing device 100.

The ROM 152 stores programs used by the MPU 150, control data such as operation parameters, and the like. The RAM 154 temporarily stores, for example, programs executed by the MPU 150, and the like.

The recording medium 156 functions as the storage unit (not shown), and stores, for example, various kinds of data such as applications. Here, as the recording medium 156, for example, there are a magnetic recording medium such as a hard disk, a non-volatile memory such as a flash memory, and the like. In addition, the recording medium 156 may be attachable to or detachable from the first information processing device 100.

The input and output interface 158 causes, for example, the operation input device 160 and the display device 162 to be connected to the bus. The operation input device 160 functions as an operation unit (not shown) and the display device 162 functions as a display unit (not shown). Here, as the input and output interface 158, for example, there are a USB (Universal Serial Bus) terminal, a DVI (Digital Visual Interface) terminal, an HDMI (High-Definition Multimedia Interface) terminal, various processing circuits, and the like. In addition, the operation input device 160 is provided on, for example, the first information processing device 100, and connected to the input and output interface 158 provided inside the first information processing device 100. As the operation input device 160, for example, there are buttons, direction keys, rotary selectors such as jog dials, a combined device thereof, and the like. In addition, the display device 162 is provided on, for example, the first information processing device 100, and connected to the input and output interface 158 provided inside the first information processing device 100. As the display device 162, for example, there are a liquid crystal display (LCD), an organic EL display (Organic Electroluminescence display, also known as an OLED (Organic Light Emitting Diode) display), and the like.

Note that it is needless to say that the input and output interface 158 can be connected to an external device such as an operation input device (for example, a keyboard, a mouse, or the like) or a display device serving as an external device of the first information processing device 100. In addition, the display device 162 may be a device that enables display and user operations, for example, a touch screen, or the like.

The communication interface 164 is a communicating section included in the first information processing device 100, and functions as the communication unit 102 for performing communication with an external device such as a server in a wireless or wired manner via the network 400 (or in a direct manner). Here, as the communication interface 164, for example, there are a communication antenna, an RF (Radio Frequency) circuit (wireless communication), an IEEE802.15.1 port and a transmission and reception circuit (wireless communication), an IEEE802.11b port and a transmission and reception circuit (wireless communication), a LAN terminal and a transmission and reception circuit (wired communication), and the like.

The first information processing device 100 performs the process of the information processing method according to the present embodiment relating to the process for signature or authentication with, for example, the configuration illustrated in FIG. 18. It should be noted that the hardware configuration of the first information processing device 100 according to the present embodiment is not limited to the configuration illustrated in FIG. 18.

For example, the first information processing device 100 may include various sensor devices such as an infrared sensor, and the like.

In addition, when the first information processing device 100 performs communication with external devices such as the second information processing device 200, the server 300, and the like, via an external communication device connected to the first information processing device via, for example, the input and output interface 158, or the like, the first information processing device 100 may not include the communication interface 164. In addition, the first information processing device 100 may also be configured not to include, for example, the operation input device 160 and the display device 162.

With reference to FIG. 17 again, the configuration example of the first information processing device 100 will be described. The communication unit 102 is a communicating section included in the first information processing device 100, and performs communication with external devices such as the second information processing device 200, the server 300, and the like, in a wireless or wired manner via the network 400 (or a direct manner). In addition, the communication of the communication unit 102 is controlled by, for example, the control unit 104. Here, as the communication unit 102, for example, there are a communication antenna, an RF circuit, a LAN terminal, a transmission and reception circuit, and the like, but the configuration of the communication unit 102 is not limited thereto. For example, the communication unit 102 can employ a configuration corresponding to an arbitrary standard that can perform communication such as a USB terminal, a transmission and reception circuit, and the like, or an arbitrary configuration that can communicate with external devices via the network 400.

The control unit 104 is configured as, for example, the MPU, and plays a role of controlling the entire first information processing device 100. In addition, the control unit 104 includes, for example, the distribution control unit 110 and the processing unit 112, and plays a leading role of performing the process of the information processing method according to the present embodiment relating to the process for signature or authentication.

The distribution control unit 110 plays a leading role of performing the process (1) (distribution control process), and causes the repetitive process in the process for signature or authentication in which the repetitive process is included to be distributively performed in one or two external devices. To be more specific, the distribution control unit 110 performs, for example, the processes relating to the first example to the third example of the process (1) (distribution control process).

The processing unit 112 plays a leading role of performing the process (2) (execution process), and performs the process for signature or authentication using processing results of the external devices that will perform the processes in a distributed manner through the process performed by the distribution control unit 110.

The control unit 104 leads the process of the information processing method according to the present embodiment relating to the process for signature or authentication (for example, the process (1) (distribution control process), and the process (2) (execution process)) using, for example, the included distribution control unit 110 and the processing unit 112.

The first information processing device 100 performs the process of the information processing method according to the present embodiment relating to the process for signature or authentication (for example, the process (1) (distribution control process), and the process (2) (execution process)) based on, for example, the configuration illustrated in FIG. 17. Thus, the first information processing device 100 can speed up the process for signature or authentication with, for example, the configuration illustrated in FIG. 17.

It should be noted that the configuration of the first information processing device according to the present embodiment is not limited to the configuration illustrated in FIG. 17.

For example, the first information processing device according to the present embodiment can include the distribution control unit 110 and the processing unit 112 illustrated in FIG. 17 in an individual manner (for example, realize each of the units as an individual processing circuit).

In addition, when the first information processing device according to the present embodiment performs communication with external devices such as the second information processing device 200, the server 300, and the like via an external communication device, for example, the first information processing device according to the present embodiment may not include the communication unit 102.

As described above, the first information processing device according to the present embodiment performs the process (1) (distribution control process), and the process (2) (execution process) as, for example, the process of the information processing method according to the present embodiment relating to the process for signature or authentication.

Here, since the repetitive process in the process for signature or authentication according to the present embodiment is a process in which an independent process is repeated, even when some or all of the processes in the repetitive process according to the present embodiment are distributively performed in external devices in the process (1) (distribution control process), the operation does not affect signature data or authentication data generated from the process (2) (execution process). In addition, by causing some or all of the processes in the repetitive process according to the present embodiment to be distributively performed in the external devices, the processing amount (amount of computation) of the process for signature according to the present embodiment performed in the first information processing device according to the present embodiment decreases.

Accordingly, the first information processing device according to the present embodiment can speed up the process for signature.

In addition, since the processing amount (amount of computation) of the process for signature or authentication according to the present embodiment performed in the first information processing device according to the present embodiment decreases due to the process of the information processing method according to the present embodiment, a load of the processes on the first information processing device according to the present embodiment is also reduced. Thus, even if the first information processing device according to the present embodiment is, for example, a device having little computing resources such as a sensor node on a sensor network, the first information processing device according to the present embodiment can execute the process for signature or authentication according to the present embodiment at a higher speed than before using the information processing method according to the present embodiment.

Furthermore, since the first information processing device according to the present embodiment causes some or all of the processes in the repetitive process according to the present embodiment to be distributively performed in the external devices, it is possible to avoid concentration of processes on one device.

### [2] Second Information Processing Device (Device Serving as a Verifier)

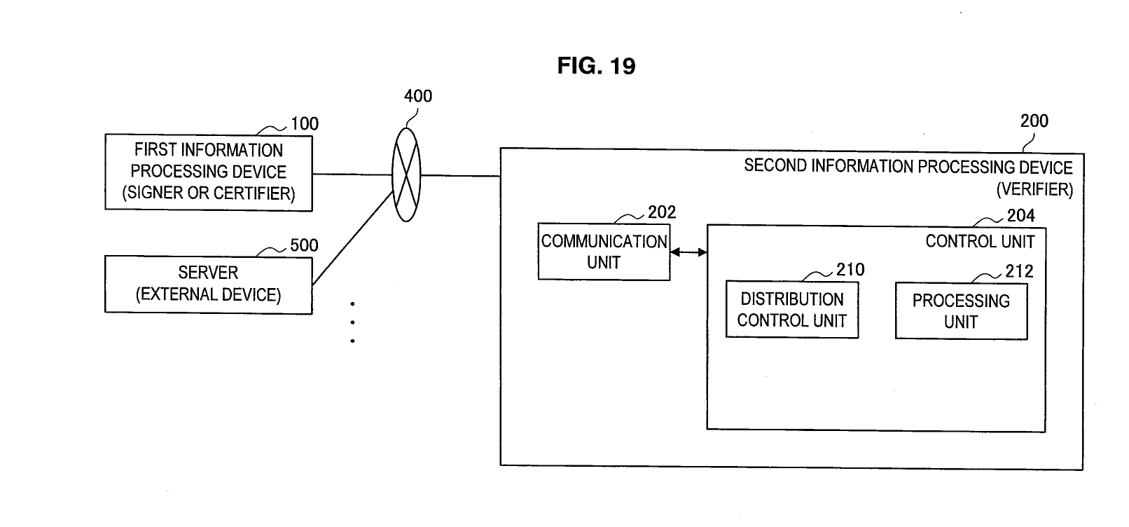

FIG. 19 is a block diagram illustrating a configuration example of the second information processing device 200 according to the present embodiment.

FIG. 19 illustrates the first information processing device 100 serving as a signer or certifier and a server 500, and the like which are external devices according to the present embodiment as well. The second information processing device 200 and the first information processing device 100, and the second information processing device 200 and the server 500, and the like perform communication via, for example, the network 400 (or in a direct manner).

The second information processing device 200 includes, for example, a communication unit 202 and the control unit 204.

In addition, the second information processing device 200 may also include, for example, a ROM (not illustrated), a RAM (not illustrated), a storage unit (not illustrated), an operation unit (not illustrated) which a user can operate, a display unit (not illustrated) on which various screens can be displayed, and the like. In the second information processing device 200, the constituent elements are connected to each other via, for example, a bus serving as a data transmission path.

Here, the ROM (not illustrated) stores programs used by the control unit 204 and control data such as operation parameters. The RAM (not illustrated) temporarily stores programs executed by the control unit 204, and the like.

The storage unit (not illustrated) is a storing section included in the second information processing device 200, and stores various kinds of data, for example, data indicating verification results and applications. Here, as the storage unit (not illustrated), for example, there are a magnetic recording medium such as a hard disk, a non-volatile memory such as a flash memory, and the like. In addition, the storage unit (not illustrated) may be attachable to or detachable from the second information processing device 200.

In addition, as the operation unit (not illustrated), for example, the operation input device illustrated in FIG. 18 described above is exemplified, and as the display unit (not illustrated), for example, the display device illustrated in FIG. 18 described above is exemplified.

### [Hardware Configuration Example of the Second Information Processing Device 200]

The second information processing device 200 employs, for example, the hardware configuration illustrated in FIG. 18, and with the configuration illustrated in FIG. 18, for example, performs the process of the information processing method according to the present embodiment relating to the process for verification.

It should be noted that the hardware configuration of the second information processing device 200 according to the present embodiment is not limited to the configuration illustrated in FIG. 18.

For example, when the second information processing device 200 performs communication with external devices such as the first information processing device 100, the server 500, and the like, via an external communication device connected to the second information processing device via, for example, the input and output interface 158, or the like, the second information processing device 200 may not include the communication interface 164. In addition, the second information processing device 200 may also be configured not to include, for example, the operation input device 160 and the display device 162.

With reference to FIG. 19 again, the configuration example of the second information processing device 200 will be described. The communication unit 202 is a communicating section included in the second information processing device 200, and performs communication with external devices such as the first information processing device 100, the server 500, and the like, in a wireless or wired manner via the network 400 (or a direct manner). In addition, the communication of the communication unit 202 is controlled by, for example, the control unit 204. Here, as the communication unit 202, for example, there are a communication antenna, an RF circuit, a LAN terminal, a transmission and reception circuit, and the like, but the configuration of the communication unit 202 is not limited thereto. For example, the communication unit 202 can employ a configuration corresponding to an arbitrary standard that can perform communication such as a USB terminal, a transmission and reception circuit, and the like, or an arbitrary configuration that can communicate with external devices via the network 400.

The control unit 204 is configured as, for example, the MPU, and plays a role of controlling the entire second information processing device 200. In addition, the control unit 204 includes, for example, a distribution control unit 210 and a processing unit 212, and plays a leading role of performing the process of the information processing method according to the present embodiment relating to the process for verification.

The distribution control unit 210 plays a leading role of performing the process (I) (distribution control process). The distribution control unit 210 divides, for example, signature data or certification data to be verified in the process for verification in which the repetitive process is included, and causes the repetitive process in the process for verification with regard to the divided signature data or certification data to be distributively performed in one or two external devices. To be more specific, the distribution control unit 210 performs, for example, the processes relating to the first example to the third example of the process (I) (distribution control process).

In addition, the distribution control unit 210 may divide processes in the repetitive process in the process for verification in which the repetitive process is included for verifying the signature data or certification data, and cause the divided processes to be distributively performed in one or two external devices.

The processing unit 212 plays a leading role of performing the process (II) (verification process), and verifies the signature data or certification data using processing results of the external devices that will perform the processes in a distributed manner through the process performed by the distribution control unit 210.

The control unit 204 leads the process of the information processing method according to the present embodiment relating to the process for verification (for example, the process (I) (distribution control process), and the process (II) (verification process)) using, for example, the included distribution control unit 210 and the processing unit 212.

The second information processing device 200 performs the process of the information processing method according to the present embodiment relating to the process for verification (for example, the process (I) (distribution control process), and the process (II) (verification process)) based on, for example, the configuration illustrated in FIG. 19. Thus, the second information processing device 200 can speed up the process for verification with, for example, the configuration illustrated in FIG. 19.

It should be noted that the configuration of the second information processing device according to the present embodiment is not limited to the configuration illustrated in FIG. 19.

For example, the second information processing device according to the present embodiment can include the distribution control unit 210 and the processing unit 212 illustrated in FIG. 19 in an individual manner (for example, realize each of the units as an individual processing circuit).

In addition, when the second information processing device according to the present embodiment performs communication with external devices such as the first information processing device 100, the server 500, and the like via an external communication device, for example, the second information processing device according to the present embodiment may not include the communication unit 202.

As described above, the second information processing device according to the present embodiment performs the process (I) (distribution control process), and the process (II) (verification process) as, for example, the process of the information processing method according to the present embodiment relating to the process for verification.

Here, since the repetitive process in the process for verification according to the present embodiment is a process in which an independent process is repeated, for example, a process in the repetitive process according to the present embodiment performed on one divided piece of signature data or certification data does not affect another process in the repetitive process according to the present embodiment performed on the other divided piece of signature data or certification data. In other words, even when the second information processing device according to the present embodiment causes the processes in the repetitive process performed on the divided signature data or certification data to be distributively performed in one or two or more external devices, the operation does not affect the result of the process for verification according to the present embodiment.

In addition, by causing the repetitive process in the process for verification with regard to the divided signature data or certification data to be distributively performed in one or two or more external devices, the processing amount (amount of computation) of the process for verification according to the present embodiment performed in the second information processing device according to the present embodiment decreases.

Accordingly, the second information processing device according to the present embodiment can speed up the process for verification.

In addition, since the processing amount (amount of computation) of the process for verification according to the present embodiment performed in the second information processing device according to the present embodiment decreases due to the process of the information processing method according to the present embodiment, a load of the processes on the second information processing device according to the present embodiment is also reduced. Thus, even if the second information processing device according to the present embodiment is, for example, a device having little computing resources, the second information processing device according to the present embodiment can execute the process for verification according to the present embodiment at a higher speed than before using the information processing method according to the present embodiment.

Furthermore, since the second information processing device according to the present embodiment causes the repetitive process in the process for verification with regard to the divided signature data or certification data to be distributively performed in one or two or more external devices, it is possible to avoid concentration of processes on one device.

Hereinabove, description has been provided exemplifying the first information processing device (device serving as a signer or authenticator performing the process of the information processing method relating to the process for signature or authentication) as the present embodiment, but the present embodiment is not limited thereto. The present embodiment can be applied to various devices, for example, devices constituting a sensor node on a sensor network, tablet-type devices, communication devices such as mobile telephones, and smartphones, video and audio reproduction devices (or video and audio recording and reproduction devices), game devices, computers such as PCs (personal computers), and the like. In addition, the present embodiment can also be applied to, for example, processing ICs (Integrated Circuits) that can be incorporated into the devices above.

In addition, description has been provided exemplifying the second information processing device (device serving as a verifier performing the process of the information processing method relating to the process for verification) as the present embodiment, but the present embodiment is not limited thereto. The present embodiment can be applied to various devices, for example, computer equipment such as PCs, servers, and the like, tablet-type devices, communication devices such as mobile telephones, and smartphones, video and audio reproduction devices (or video and audio recording and reproduction devices), game devices, and the like. In addition, the present embodiment can also be applied to, for example, processing ICs that can be incorporated into the devices above.

In addition, as the present embodiment, description has been provided exemplifying the external devices with respect to each of the first information processing device according to the present embodiment and the second information processing device according to the present embodiment, but the present embodiment is not limited thereto. The present embodiment can be applied to various devices that enable execution of the process of the information processing method according to the present embodiment, for example, devices constituting a sensor node on a sensor network, tablet-type devices, communication devices such as mobile telephones and smartphones, video and audio reproduction devices (or video and audio recording and reproduction devices), game devices, computer equipment such as PCs, servers, and the like. In addition, the external devices according to the present embodiment employ the hardware configuration as illustrated in, for example, FIG. 18, but the hardware configuration of the external devices according to the present embodiment is not limited thereto.

### (Program According to the Present Embodiment)

The process for signature or authentication can be sped up by executing a program (for example, a program that enables the execution of the process of the information processing method according to the present embodiment relating to the process for signature or authentication such as the process (1) (distribution control process) and the process (2) (execution process)) for instructing a computer to function as the first information processing device according to the present embodiment (the device serving as a signer or authenticator performing the process of the information processing method relating to the process for signature or authentication) in the computer.

In addition, the process for verification can be sped up by executing a program (for example, a program that enables the execution of the process of the information processing method according to the present embodiment relating to the process for verification such as the process (I) (distribution control process) and the process (II) (verification process)) for instructing a computer to function as the second information processing device according to the present embodiment (the device serving as a verifier performing the process of the information processing method relating to the process for verification) in the computer.

Hereinabove, the preferred embodiment of the present technology has been described in detail with reference to the appended drawings, but the technical scope of the present technology is not limited thereto. It should be understood by those skilled in the art that various modifications, combinations, sub-combinations and alterations may occur depending on design requirements and other factors insofar as they are within the scope of the appended claims or the equivalents thereof.

For example, the above description has introduced that the programs (computer program) for instructing a computer to function as the first information processing device according to the present embodiment (the device serving as a signer or authenticator performing the process of the information processing method relating to the process for signature or authentication) or the second information processing device according to the present embodiment (the device serving as a verifier performing the process of the information processing method relating to the process for verification) are provided, but a recording medium that stores each of the programs or the programs together can be provided as well.

The above-described configuration is an example of the present embodiment, and of course falls within the technical scope of the present technology.

Additionally, the present technology may also be configured as below.

(1) An information processing device including:

a distribution control unit configured to cause one or two external devices to distributively perform a repetitive process in a process for signature or authentication in which the repetitive process is included; and

a processing unit configured to perform the process for signature or authentication using a processing result of each of the external devices.

(2) The information processing device according to (1), wherein the distribution control unit is configured to cause a plurality of external devices to distributively perform the repetitive process in the process for signature or authentication.
(3) The information processing device according to (2), wherein the distribution control unit is configured to equally divide the repetitive process in the process for signature or authentication into a number of the external devices, and cause the plurality of external devices to perform the divided repetitive process.
(4) The information processing device according to (2), wherein the distribution control unit is configured to unequally divide the repetitive process in the process for signature or authentication into a number of the external devices, and cause the plurality of external devices to perform the divided repetitive process.
(5) The information processing device according to (1), wherein the distribution control unit is configured to cause one or two or more external devices and the processing unit to distributively perform the repetitive process in the process for signature or authentication.
(6) The information processing device according to (5), wherein the distribution control unit is configured to equally divide the repetitive process in the process for signature or authentication into a total number of the external devices and the processing unit, and cause the external devices and the processing unit to perform the divided repetitive process.
(7) The information processing device according to (5), wherein the distribution control unit is configured to unequally divide the repetitive process in the process for signature or authentication into a total number of the external devices and the processing unit, and cause the external devices and the processing unit to perform the divided repetitive process.
(8) An information processing device including:

a distribution control unit configured to divide signature data or certification data to be verified in a process for verification in which a repetitive process is included, and cause one or two external devices to distributively perform the repetitive process in the process for verification with regard to the divided signature data or certification data; and

a processing unit configured to verify the signature data or the certification data using a processing result of each of the external devices.

(9) The information processing device according to (8), wherein the distribution control unit is configured to cause a plurality of external devices to distributively perform the repetitive process in the process for verification with regard to the divided signature data or certification data.
(10) The information processing device according to (9), wherein the distribution control unit is configured to equally divide the signature data or the certification data into a number of the external devices, and cause the plurality of external devices to perform the repetitive process in the process for verification with regard to the divided signature data or certification data.
(11) The information processing device according to (9), wherein the distribution control unit is configured to unequally divide the signature data or the certification data into a number of the external devices, and cause the plurality of external devices to perform the repetitive process in the process for verification with regard to the divided signature data or certification data.
(12) The information processing device according to (8), wherein the distribution control unit is configured to cause one or two or more external devices and the processing unit to distributively perform the repetitive process in the process for verification with regard to the divided signature data or certification data.
(13) The information processing device according to (12), wherein the distribution control unit is configured to equally divide the signature data or the certification data into a total number of the external devices and the processing unit, and cause the external devices and the processing unit to perform the repetitive process in the process for verification with regard to the divided signature data or certification data.
(14) The information processing device according to (12), wherein the distribution control unit is configured to unequally divide the signature data or the certification data into a total number of the external devices and the processing unit, and cause the external devices and the processing unit to perform the repetitive process in the process for verification with regard to the divided signature data or certification data.
(15) The information processing device according to any one of (8) to (14), wherein the processing unit is configured to transmit a verification result of the signature data or the certification data to each of the external devices.
(16) An information processing device including:

a distribution control unit configured to divide a process in a repetitive process in the process for verification in which the repetitive process for verifying signature data or certification data is included, and cause one or two external devices to distributively perform the divided process; and

a processing unit configured to verify the signature data or the certification data using a processing result of each of the external devices.

(17) An information processing method including:

causing one or two external devices to distributively perform a repetitive process in the process for signature or authentication in which the repetitive process is included; and

performing the process for signature or authentication using a processing result of each of the external devices.

(18) An information processing method including:

dividing signature data or certification data to be verified in a process for verification in which a repetitive process is included, and causing one or two external devices to distributively perform the repetitive process in the process for verification with regard to the divided signature data or certification data; and

verifying the signature data or the certification data using a processing result of each of the external devices.

(19) A program for causing a computer to execute:

causing one or two external devices to distributively perform a repetitive process in a process for signature or authentication in which the repetitive process is included; and

performing the process for signature or authentication using a processing result of each of the external devices.

(20) A program for causing a computer to execute:

dividing signature data or certification data to be verified in a process for verification in which a repetitive process is included, and causing one or two external devices to distributively perform the repetitive process in the process for verification with regard to the divided signature data or certification data; and

verifying the signature data or the certification data using a processing result of each of the external devices.

The present disclosure contains subject matter related to that disclosed in Japanese Priority Patent Application JP 2012-199410 filed in the Japan Patent Office on Sep. 11, 2012, the entire content of which is hereby incorporated by reference.

What is claimed is:

1. An information processing device comprising:
a distribution control unit configured to cause one or two external devices to distributively perform a repetitive process in a process for signature or authentication in which the repetitive process is included; and
a processing unit configured to perform the process for signature or authentication using a processing result of each of the external devices.

2. The information processing device according to claim 1, wherein the distribution control unit is configured to cause a plurality of external devices to distributively perform the repetitive process in the process for signature or authentication.

3. The information processing device according to claim 2, wherein the distribution control unit is configured to equally divide the repetitive process in the process for signature or authentication into a number of the external devices, and cause the plurality of external devices to perform the divided repetitive process.

4. The information processing device according to claim 2, wherein the distribution control unit is configured to unequally divide the repetitive process in the process for signature or authentication into a number of the external devices, and cause the plurality of external devices to perform the divided repetitive process.

5. The information processing device according to claim 1, wherein the distribution control unit is configured to cause one or two or more external devices and the processing unit to distributively perform the repetitive process in the process for signature or authentication.

6. The information processing device according to claim 5, wherein the distribution control unit is configured to equally divide the repetitive process in the process for signature or authentication into a total number of the external devices and the processing unit, and cause the external devices and the processing unit to perform the divided repetitive process.

7. The information processing device according to claim 5, wherein the distribution control unit is configured to unequally divide the repetitive process in the process for signature or authentication into a total number of the external devices and the processing unit, and cause the external devices and the processing unit to perform the divided repetitive process.

8. An information processing device comprising:
a distribution control unit configured to divide signature data or certification data to be verified in a process for verification in which a repetitive process is included, and cause one or two external devices to distributively perform the repetitive process in the process for verification with regard to the divided signature data or certification data; and
a processing unit configured to verify the signature data or the certification data using a processing result of each of the external devices.

9. The information processing device according to claim 8, wherein the distribution control unit is configured to cause a plurality of external devices to distributively perform the repetitive process in the process for verification with regard to the divided signature data or certification data.

10. The information processing device according to claim 9, wherein the distribution control unit is configured to equally divide the signature data or the certification data into a number of the external devices, and cause the plurality of external devices to perform the repetitive process in the process for verification with regard to the divided signature data or certification data.

11. The information processing device according to claim 9, wherein the distribution control unit is configured to unequally divide the signature data or the certification data into a number of the external devices, and cause the plurality of external devices to perform the repetitive process in the process for verification with regard to the divided signature data or certification data.

12. The information processing device according to claim 8, wherein the distribution control unit is configured to cause one or two or more external devices and the processing unit to distributively perform the repetitive process in the process for verification with regard to the divided signature data or certification data.

13. The information processing device according to claim 12, wherein the distribution control unit is configured to equally divide the signature data or the certification data into a total number of the external devices and the processing unit, and cause the external devices and the processing unit to perform the repetitive process in the process for verification with regard to the divided signature data or certification data.

14. The information processing device according to claim 12, wherein the distribution control unit is configured to unequally divide the signature data or the certification data into a total number of the external devices and the processing unit, and cause the external devices and the processing unit to perform the repetitive process in the process for verification with regard to the divided signature data or certification data.

15. The information processing device according to claim 8, wherein the processing unit is configured to transmit a verification result of the signature data or the certification data to each of the external devices.

16. An information processing device comprising:
a distribution control unit configured to divide a process in a repetitive process in the process for verification in which the repetitive process for verifying signature data or certification data is included, and cause one or two external devices to distributively perform the divided process; and
a processing unit configured to verify the signature data or the certification data using a processing result of each of the external devices.

17. An information processing method comprising:
causing one or two external devices to distributively perform a repetitive process in the process for signature or authentication in which the repetitive process is included; and
performing the process for signature or authentication using a processing result of each of the external devices.

18. An information processing method comprising:
dividing signature data or certification data to be verified in a process for verification in which a repetitive process is included, and causing one or two external devices to distributively perform the repetitive process in the process for verification with regard to the divided signature data or certification data; and
verifying the signature data or the certification data using a processing result of each of the external devices.

19. A program for causing a computer to execute:
causing one or two external devices to distributively perform a repetitive process in a process for signature or authentication in which the repetitive process is included; and
performing the process for signature or authentication using a processing result of each of the external devices.

20. A program for causing a computer to execute:
dividing signature data or certification data to be verified in a process for verification in which a repetitive process is included, and causing one or two external devices to distributively perform the repetitive process in the process for verification with regard to the divided signature data or certification data; and
verifying the signature data or the certification data using a processing result of each of the external devices.
